(19) United States
(12) Patent Application Publication
(10) Pub. No.: US 2026/0332914 A1
(43) Pub. Date: Oct. 22, 2026

(54) IMAGING DEVICE

(71) Applicant: SONY SEMICONDUCTOR SOLUTIONS CORPORATION, KANAGAWA (JP)

(72) Inventor: MAMORU SATO, KANAGAWA (JP)

(21) Appl. No.: 19/104,355

(22) PCT Filed: Jun. 30, 2023
(86) PCT No.: PCT/JP2023/024442

§ 371 Date: Feb. 17, 2025

(30) Foreign Application Priority Data
Aug. 25, 2022 (JP) 2022-134128

(51) Int. Cl. H04N 25/78; H04N 25/46; H04N 25/772

(52) U.S. Cl. CPC H04N 25/78; H04N 25/46; H04N 25/772

(57) ABSTRACT

Binning is enabled while suppressing an increase in the number of switches connected to a signal line that transmits signals read out from pixels in a column direction. An imaging device includes a pixel array unit in which pixels are arranged in a matrix in a row direction and a column direction; a signal line that transmits signals read out from the pixels in the column direction; a sample-and-hold switch that samples and holds the signals, which are transmitted via the signal line, for each column; and a connection switch that connects signal lines of different columns in which the signals are sampled and held. The imaging device may further include an AD conversion unit that performs AD conversion for each of the columns of the signals transmitted via the signal lines; and an active control unit that activates one AD conversion unit out of the AD conversion units of each column connected via the connection switch.

### TECHNICAL FIELD

The present technology relates to an imaging device. More specifically, the present technology relates to an imaging device equipped with a binning function.

### BACKGROUND ART

For cameras mounted on surveillance cameras and mobile terminals, there is a technology that operates a camera continuously for purposes such as moving object detection, and that reduces power consumption by lowering spatial resolution using analog binning. As such an imaging device, for example, an imaging device has been proposed that holds one pixel signal in each of a plurality of signal holding units, averages the pixel signals held in the plurality of signal holding units, and outputs the pixel signal (see, for example, PTL 1).

### CITATION LIST

### Patent Literature

[PTL 1] JP 2020-92353 A

### SUMMARY

### Technical Problem

However, in the above-mentioned conventional technology, a first switch circuit selectively connects the pixel to each of the plurality of signal holding units to hold one pixel signal in each of the plurality of signal holding units, and a second switch circuit averages and outputs the pixel signals held in the plurality of signal holding units. For this reason, in the above-mentioned conventional technology, the number of switches connected to the signal line that transmits, in the column direction, the signal read from the pixel increases, and this may lead to an increase in the area occupied by the switches.

The present technology has been made in view of such circumstances, and aims to enable binning while suppressing an increase in the number of switches connected to the signal line that transmits, in the column direction, the signal read out from the pixel.

### Solution to Problem

The present technology has been made to solve the above-mentioned problems, and a first aspect thereof provides an imaging device including: a pixel array unit in which pixels are arranged in a matrix in a row direction and a column direction; a signal line that transmits signals read out from the pixels in the column direction; a sample-and-hold switch that samples and holds the signals, which are transmitted via the signal line, for each column; and a connection switch that connects signal lines of different columns in which the signals are sampled and held. This elicits an effect by which binning is performed after the signals transmitted via the signal lines are sampled and held for each column.

In addition, in the first aspect, the imaging device may further include an AD conversion unit that performs AD conversion for each of the columns of the signals transmitted via the signal line; and an active control unit that activates one AD conversion unit out of the AD conversion units of each column connected via the connection switch. This elicits an effect by which power consumption of the AD conversion unit that does not need to operate during binning processing is reduced.

In addition, in the first aspect, the AD conversion unit may include a comparator that compares a potential of the signal line with a ramp signal; and a counter that performs a counting operation, based on a comparison result from the comparator. This elicits an effect by which the signal transmitted via the signal line is digitized.

In addition, in the first aspect, the active control unit may control the AD conversion units, separately, for columns to be activated and columns to be deactivated. This elicits an effect by which the AD conversion unit of at least one of the plurality of columns is deactivated during binning.

In addition, in the first aspect, the device may further include a first DC-cut capacitor connected to a first input terminal of the comparator; and a second DC-cut capacitor connected to a second input terminal of the comparator. This elicits an effect by which a DC-cut signal is input to the comparator.

In addition, in the first aspect, the active control unit may further include a changeover switch that switches between the first input terminal of the comparator and a ground a connection destination of a second capacitance electrode of the first DC-cut capacitor having a first capacitance electrode being connected to the signal line. This elicits an effect by which the capacitance of the first DC-cut capacitor of a column is added to the signal line of another column.

In addition, in the first aspect, the active control unit may control the changeover switch, separately, for columns to be activated and columns to be deactivated. This elicits an effect by which the capacitance added to the column to be deactivated is added to the capacitance of the signal line of the column to be activated.

In addition, in the first aspect, the device may further include an amplifier that amplifies, for each column, signals transmitted via the signal line and inputs the amplified signals to the AD conversion unit. This elicits an effect by which the signal input to the AD conversion unit is increased.

In addition, in the first aspect, the active control unit may control the amplifier, separately, for columns to be activated and columns to be deactivated. This elicits an effect by which the amplifier of at least one column out of the plurality of columns is deactivated during binning.

In addition, in the first aspect, the sample-and-hold switch may be a transistor provided for each signal line. This elicits an effect by which the signal transmitted via the signal line is sampled and held for each column.

In the first aspect, the device may further include a driver that drives the transistor from both sides in the row direction. This elicits an effect by which the driving force of the transistor of each column is increased based on two drivers provided in common to a plurality of columns.

In the first aspect, the device may further include a signal line reset transistor that resets the potential of the signal line; and a signal line reset level generating unit that generates a reset level of the potential of the signal line. This elicits an effect by which capacitive load readout is possible based on the potential of the signal line reset to a voltage higher than 0 V.

In the first aspect, the signal line reset level generating unit may include a diode-connected transistor. This elicits an effect by which the potential of the signal line is raised according to the forward voltage of the diode-connected transistor when the signal line is reset.

In the first aspect, the capacitance used for sampling and holding the signal may be a parasitic capacitance of the signal line. This elicits an effect by which capacitive load readout is possible without adding a capacitive element to the signal line.

In addition, in the first aspect, the connection switch may be connected, in series, to a capacitance for each column used for sampling and holding the signal. This elicits an effect by which binning is possible while the number of columns to be binned is variable.

In addition, in the first aspect, the connection switch may be connected, in parallel, to a capacitance for each column used for sampling and holding the signal. This elicits an effect by which binning is possible while the number of columns to be binned is fixed.

In addition, in the first aspect, the device further includes a constant current transistor electrically connectable to the signal line and passing a constant current, based on a source follower formed between the signal line and the pixel, wherein the constant current transistor is turned on during constant current readout, and the constant current transistor is turned off during capacitive load readout. This elicits an effect by which capacitive load readout and constant current readout can be switched.

In the first aspect, the pixel may include a photodiode; a transfer transistor that transfers charges stored in the photodiode to a floating diffusion; a reset transistor that resets the floating diffusion; an amplification transistor that outputs a signal corresponding to a potential of the floating diffusion; and a selection transistor connected between the amplification transistor and the signal line. This elicits an effect by which a source follower is formed between the pixel and the amplification transistor when reading out signals from the pixel.

In the first aspect, the sample-and-hold switch may be the selection transistor. This elicits an effect by which a signal transmitted via the signal line is sampled and held for each column.

In the first aspect, the pixel may further include a binning transistor that connects floating diffusions of different rows. This elicits an effect by which binning of different rows is enabled.

### BRIEF DESCRIPTION OF DRAWINGS

FIG. 1 is a block diagram showing an example of the configuration of a camera to which an imaging device according to a first embodiment is applied.

FIG. 2 is a block diagram showing an example of the configuration of a solid-state imaging device according to a first embodiment.

FIG. 3 is a block diagram showing an example of the circuit configuration of a pixel provided in the solid-state imaging device according to the first embodiment.

FIG. 4 is a cross-sectional view showing an example of the configuration of a pixel array unit provided in the solid-state imaging device according to the first embodiment.

FIG. 5 is a cross-sectional view showing a modified example of a pixel array unit provided in the solid-state imaging device according to the first embodiment.

FIG. 6 is a diagram showing an example of the configuration of a signal readout circuit for four columns according to the first embodiment.

FIG. 7 is a diagram showing an example of the waveforms of each part during signal readout of the imaging device according to the first embodiment.

FIG. 8 is a diagram showing an example of the configuration of a comparator applied to a signal readout circuit according to the first embodiment.

FIG. 9 is a diagram showing an example of the configuration of a signal readout circuit for four columns according to a second embodiment.

FIG. 10 is a diagram showing an example of the configuration of a signal readout circuit for four columns according to a third embodiment.

FIG. 11 is a diagram showing an example of the configuration of a signal readout circuit for two columns according to a fourth embodiment.

FIG. 12 is a diagram showing an example of the configuration of a signal readout circuit for four columns according to a fifth embodiment.

FIG. 13 is a diagram showing an example of the configuration of a signal readout circuit for four columns according to a sixth embodiment.

FIG. 14 is a diagram showing an example of the waveforms of each part during signal readout of an imaging device according to the sixth embodiment.

FIG. 15 is a diagram showing an example of the configuration of a signal readout circuit for four columns according to a seventh embodiment.

FIG. 16 is a diagram showing an example of the configuration of a signal readout circuit for four columns according to an eighth embodiment.

FIG. 17 is a diagram showing an example of the waveforms of each part during signal readout of an imaging device according to the eighth embodiment.

FIG. 18 is a diagram showing an example of the configuration of a signal readout circuit for one column according to a ninth embodiment.

FIG. 19 is a perspective view showing an example of the configuration of an imaging device according to a tenth embodiment.

FIG. 20 is a block diagram showing a schematic example of the configuration of a vehicle control system.

FIG. 21 is an explanatory diagram showing an example of the installation position of an imaging unit.

### DESCRIPTION OF EMBODIMENTS

Modes for carrying out the present technology (hereinafter also referred to as “embodiments”) will be described below. The description will be given in the following order.
1. First embodiment (example in which signal line reset transistor performs binning based on signal sampled and held for each column connected to vertical signal line)
2. Second embodiment (example in which diode-connected transistor performs binning based on signal sampled and held for each column connected to vertical signal line via signal line reset transistor)
3. Third embodiment (example in which signal line reset transistor performs binning based on signal sampled and held for each column connected to vertical signal line, and connection switch is connected in parallel to capacitance of each column used for sampling-and-holding)
4. Fourth embodiment (example in which signal line reset transistor performs binning in row and column directions based on signal sampled and held for each column connected to vertical signal line)
5. Fifth embodiment (example in which amplifier that amplifies signal input to AD conversion unit is provided for each column)
6. Sixth embodiment (example in which driver is provided to drive sample-and-hold switch provided for each signal line from both sides in row direction)
7. Seventh embodiment (example in which connection destination of DC-cut capacitor is switched between comparator input and ground)
8. Eighth embodiment (example in which constant current transistor performs binning based on signal sampled and held for each column connected to vertical signal line)
9. Ninth embodiment (example in which constant current transistors are connected in parallel to series circuit of signal line reset transistor and diode-connected transistor)
10. Tenth embodiment (example in which substrate on which solid-state imaging device is formed is stacked)
11. Example of application to mobile object

### 1. First Embodiment

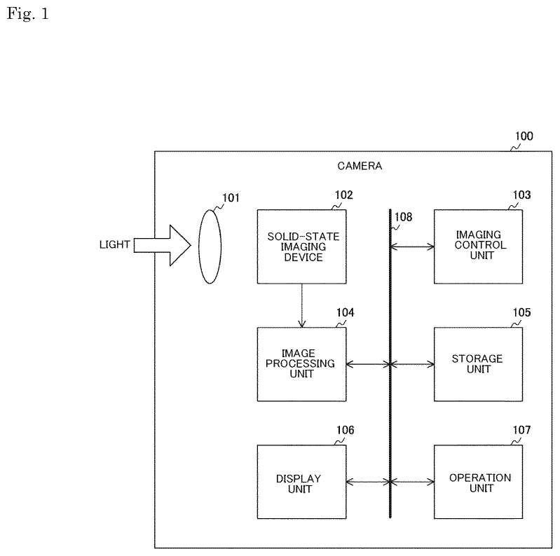

FIG. 1 is a block diagram showing an example of the configuration of a camera to which an imaging device according to the first embodiment is applied.

In the FIGURE, the camera 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are connected to each other via a bus 108. The camera 100 may be used as a standalone device, or may be incorporated into a mobile terminal such as a smartphone, or may be incorporated into an authentication device or a monitoring device.

The optical system 101 causes light from a subject to be incident on the solid-state imaging device 102, and forms an image of the subject on the light-receiving surface of the solid-state imaging device 102. The optical system 101 may include, for example, a focus lens, a zoom lens, and an aperture. The optical system 101 may include a plurality of lenses, such as a wide-angle lens, a standard lens, and a telephoto lens.

The solid-state imaging device 102 converts light from a subject into an electrical signal for each pixel, digitizes the electrical signal, and outputs it. The solid-state imaging device 102 may be, for example, a CMOS (Complementary Metal Oxide Semiconductor) image sensor or a CCD (Charge Coupled Device).

The imaging control unit 103 controls imaging by the solid-state imaging device 102 based on a command from the operation unit 107. At this time, the imaging control unit 103 can control the exposure time, exposure amount, imaging timing, and the like of the solid-state imaging device 102.

The image processing unit 104 performs image processing based on the output from the solid-state imaging device 102. The image processing is, for example, gamma correction, white balance processing, sharpness processing, and gradation conversion processing. The image processing unit 104 may include a processor that executes processing based on software.

The storage unit 105 stores the captured image captured by the solid-state imaging device 102, and stores the imaging parameters and the like of the solid-state imaging device 102. The storage unit 105 can also store a program that operates the camera 100 based on software. The storage unit 105 may include a ROM (Read Only Memory), a RAM (Random Access Memory), and a memory card.

The display unit 106 displays the captured image and various pieces of information that supports the imaging operation. The display unit 106 may be a liquid crystal display or an organic EL (Electro Luminescence) display.

The operation unit 107 provides a user interface for operating the camera 100. The operation unit 107 may include, for example, buttons, dials, and switches provided on the camera 100. The operation unit 107 may be configured as a touch panel together with the display unit 106.

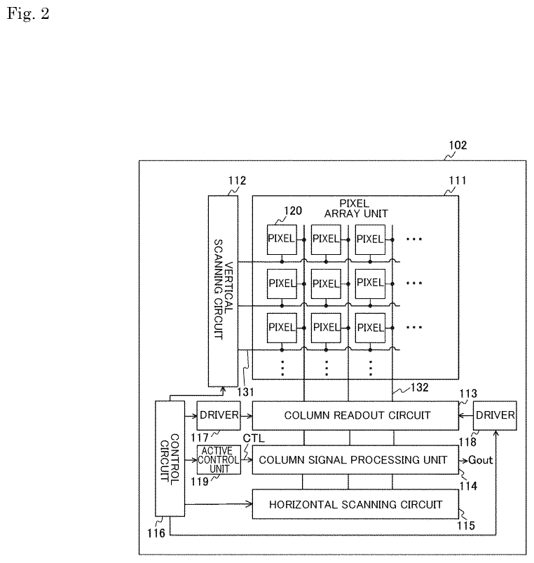

FIG. 2 is a block diagram showing an example of the configuration of the solid-state imaging device according to the first embodiment.

In the FIGURE, the solid-state imaging device 102 includes a pixel array unit 111, a vertical scanning circuit 112, a column readout circuit 113, a column signal processing unit 114, a horizontal scanning circuit 115, a control circuit 116, drivers 117 and 118, and an active control unit 119.

The pixel array unit 111 includes a plurality of pixels 120. The pixels 120 are arranged in a matrix along the row direction (also called the horizontal direction) and the column direction (also called the vertical direction). Each pixel 120 can form a source follower with the column readout circuit 113 when reading out signals. Each pixel 120 is connected to a horizontal drive line 131 for each row, and to a vertical signal line 132 for each column. The horizontal drive line 131 drives each pixel 120 for each row when reading out signals from each pixel 120. The vertical signal line 132 transmits a potential based on a stored charge according to a current flowing when reading out signals from the pixel 120 to the column signal processing unit 114 for each column. Note that the vertical signal line 132 is an example of a signal line described in the claims.

The vertical scanning circuit 112 scans the pixels 120 to be read out in the column direction. The vertical scanning circuit 112 may be configured using a vertical register.

The column readout circuit 113 can form a source follower with each pixel 120 when reading out signals from each pixel 120. At this time, the column readout circuit 113 can change the potential of the vertical signal line 132 based on the charge held in the pixel 120. The column readout circuit 113 can support capacitive load readout. The column readout circuit 113 may also support constant current readout.

The column readout circuit 113 also includes a sample-and-hold switch that samples and holds the signal transmitted via the vertical signal line 132 for each column, and a connection switch that connects the vertical signal lines 132 of different columns whose signals are sampled and held. At this time, the column readout circuit 113 can sample and hold the signal transmitted via the vertical signal line 132 for each column, and then perform binning and output the signal to the column signal processing unit 114.

The drivers 117 and 118 drive the sample-hold switches provided in the column readout circuit 113 from both sides in the row direction. The drivers 117 and 118 can be shared by the sample-hold switches provided for each column. The drivers 117 and 118 can be arranged on both sides of the column readout circuit 113.

The column signal processing unit 114 processes signals transmitted in the column direction from each pixel 120. For example, the column signal processing unit 114 can perform correlated double sampling (CDS) processing based on the signals transmitted in the column direction from each pixel 120. In addition, the column signal processing unit 114 can perform AD (Analog to Digital) conversion processing based on the signals transmitted in the column direction from each pixel 120 and output an imaging signal Gout. At this time, the column signal processing unit 114 can be provided with an AD conversion unit for each column that AD-converts the signals transmitted via the vertical signal line 132.

The active control unit 119 activates one of the AD conversion units of each column connected via the connection switch. At this time, the active control unit 119 can output a control signal CTL to each AD conversion unit, which controls the activation timing of each AD conversion unit during binning. The active control unit 119 may control the AD conversion units separately for columns to be activated and columns to be deactivated. At this time, the active control unit 119 can activate the AD conversion unit of the column to be activated and put the AD conversion unit of the column to be deactivated into a standby state.

The horizontal scanning circuit 115 scans the pixels 120 to be read in the row direction. The horizontal scanning circuit 115 may be configured using a horizontal register.

The control circuit 116 controls the vertical scanning circuit 112, the column readout circuit 113, the column signal processing unit 114, the horizontal scanning circuit 115, and the drivers 117 and 118. For example, the control circuit 116 can control the scanning timing in the column direction, the scanning timing in the row direction, the operation timing of the column readout circuit 113, and the processing timing of the column signal processing unit 114. The control circuit 116 can also control the driving timing of the drivers 117 and 118 and the operation timing of the active control unit 119.

In the configuration example of FIG. 2, a sample-and-hold switch is provided in the column readout circuit 113 to perform binning based on the signal sampled and held for each column. A selection transistor provided in the pixel 120 may be used for sampling and holding the signal read out from the pixel 120 for each column. In this method, the sample-and-hold switch provided in the column readout circuit 113 is not necessary. The drivers 117 and 118 on both sides of the column readout circuit 113 are also not necessary.

In addition, the binning readout and all-pixel individual readout may be switched depending on the application of the camera 100. For example, in a mobile terminal equipped with the camera 100, when an application such as motion detection is started, the binning process may be constantly operated, and when an application such as still-image capture is started, the binning process may be switched to all-pixel individual readout.

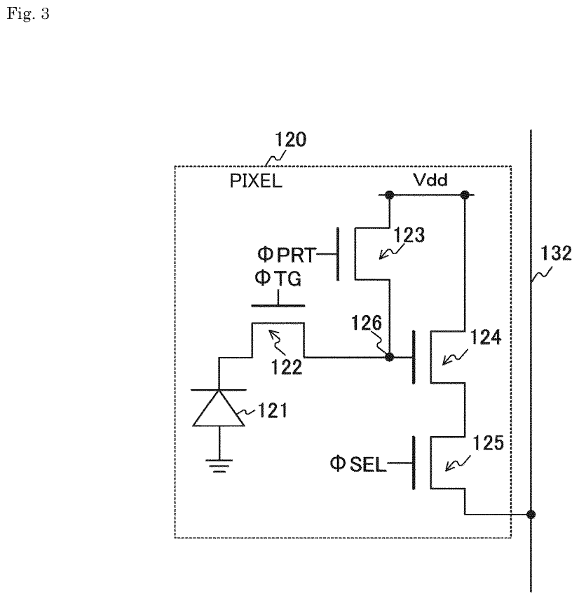

FIG. 3 is a block diagram showing an example of a circuit configuration of a pixel provided in the solid-state imaging device according to the first embodiment.

In the FIGURE, the pixel 120 includes a photodiode 121, a transfer transistor 122, a reset transistor 123, an amplification transistor 124, a selection transistor 125, and a floating diffusion 126. MOS (Metal Oxide Semiconductor) transistors can be used as the transfer transistor 122, the reset transistor 123, the amplification transistor 124, and the selection transistor 125.

The amplification transistor 124 and the selection transistor 125 are connected in series. The cathode of the photodiode 121 is connected to the floating diffusion 126 via the transfer transistor 122. The floating diffusion 126 is also connected to a power supply Vdd via the reset transistor 123. The power supply Vdd is also connected to the vertical signal line 132 via a series circuit of the amplification transistor 124 and the selection transistor 125. The gate of the amplification transistor 124 is connected to the floating diffusion 126.

A transfer signal ΦTG is applied to the gate of the transfer transistor 122. A pixel reset signal ΦPRT is applied to the gate of the reset transistor 123. A selection signal ΦSEL is applied to the gate of the selection transistor 125. The transfer signal ΦTG, pixel reset signal ΦPRT and selection signal ΦSEL can be transmitted to each pixel 120 via the horizontal drive line 131 in FIG. 2.

When the transfer transistor 122 is turned on, the charge stored in the photodiode 121 is transferred to the floating diffusion 126. When the selection transistor 125 is turned on, the source potential of the amplification transistor 124 changes according to the potential of the floating diffusion 126. The source potential of the amplification transistor 124 is applied to the vertical signal line 132 via the selection transistor 125 and transmitted via the vertical signal line 132. When the reset transistor 123 is turned on, the charge stored in the floating diffusion 126 is discharged.

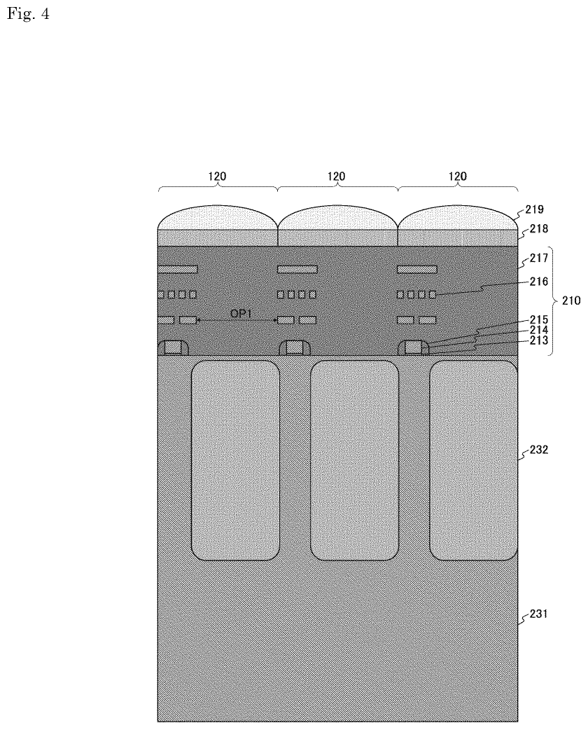

FIG. 4 is a cross-sectional view showing an example of the configuration of a pixel array unit provided in the solid-state imaging device according to the first embodiment. Note that FIG. 4 shows an example of a front-illuminated solid-state imaging device. FIG. 4 also shows an example of the configuration for three pixels.

In the FIGURE, a photodiode 232 is formed for each pixel 120 on a semiconductor substrate 231. The semiconductor substrate 231 may be made of, Si, InGaAs, or InP.

A gate electrode 214 and a wiring layer 210 are formed on the semiconductor substrate 231. The gate electrode 214 is formed on the semiconductor substrate 231 via a gate-insulating film 213. A sidewall 215 is formed on the sidewall of the gate electrode 214. The gate electrode 214 may be made of, for example, polycrystalline silicon doped with impurities. The gate-insulating film 213 may be made of, for example, a silicon oxide film. The sidewall 215 may be made of, for example, a silicon oxide film or a silicon nitride film.

The gate electrode 214 may be used for a pixel transistor. The pixel transistor includes the transfer transistor 122, the reset transistor 123, the amplification transistor 124, and the selection transistor 125 of FIG. 3.

A wiring 216 is formed on the gate electrode 214. FIG. 4 shows an example of a three-layer wiring. At this time, the wiring 216 is provided with an opening OP1 that allows light to enter the photodiode 232. The gate electrode 214 and the wiring 216 are insulated via an insulating layer 217. The insulating layer 217 may be made of, for example, a silicon oxide film. The wiring 216 may be made of, for example, a metal such as Al or Cu.

A color filter 218 is formed for each pixel 120 on the wiring layer 210. A microlens 219 is formed for each pixel 120 on the color filter 218. The color filter 218 and the microlens 219 may be made of, for example, a transparent resin such as acrylic or polycarbonate. The color filter 218 may be colored by adding a pigment. The color filter 218 may be arranged in, for example, a Bayer array.

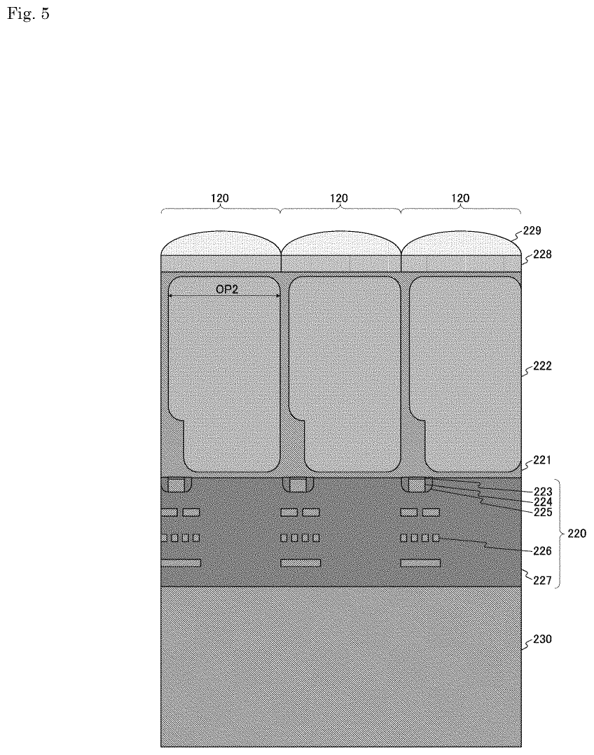

FIG. 5 is a cross-sectional view showing a modified example of a pixel array unit provided in the solid-state imaging device according to the first embodiment. FIG. 5 shows an example of a back-illuminated solid-state imaging device. FIG. 5 also shows a configuration example for three pixels.

In the FIGURE, a photodiode 222 is formed for each pixel 120 in the semiconductor layer 221. The semiconductor layer 221 may be made of, Si, InGaAs, or InP. The semiconductor layer 221 can be formed, for example, by thinning a semiconductor substrate having the photodiode 222 formed on the front side from the back side.

A gate electrode 224 and a wiring layer 220 are formed on the semiconductor layer 221. The gate electrode 224 is formed on the semiconductor layer 221 via a gate-insulating film 223. A sidewall 225 is formed on the side wall of the gate electrode 224.

The gate electrode 224 can be used for a pixel transistor. The pixel transistor includes the transfer transistor 122, the reset transistor 123, the amplification transistor 124, and the selection transistor 125 of FIG. 3.

A wiring 226 is formed on the gate electrode 224. FIG. 5 shows an example of a three-layer wiring. The gate electrode 224 and the wiring 226 are insulated via an insulating layer 227. The semiconductor layer 221 is supported on a support substrate 230 via the insulating layer 227. The support substrate 230 may be a glass substrate, a Si substrate, or a sapphire substrate.

A color filter 228 is formed for each pixel 120 on the back side of the semiconductor layer 221. A microlens 229 is formed for each pixel 120 on the color filter 228. The color filter 228 may be arranged in a Bayer array, for example.

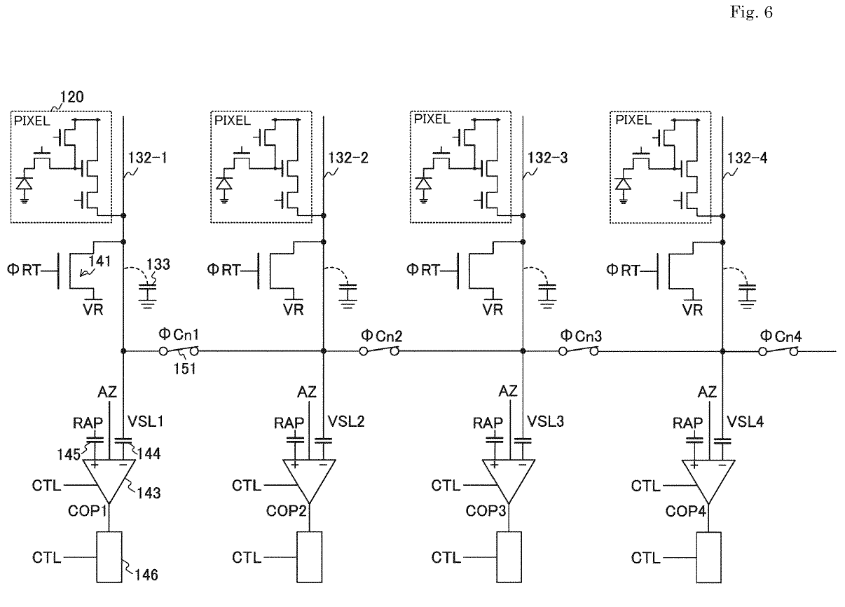

FIG. 6 is a diagram showing an example of the configuration of a signal readout circuit for four columns according to the first embodiment.

In the FIGURE, the pixels 120 are connected to the vertical signal lines 132-1 to 132-4, respectively. At this time, the amplification transistor 124 of each pixel 120 is connected to the vertical signal lines 132-1 to 132-4 via the selection transistor 125. In addition, a capacitance 133 is added to the vertical signal lines 132-1 to 132-4. This capacitance 133 can be used for sampling and holding the signal read out from each pixel 120 for each column. This capacitance 133 may be a parasitic capacitance of the vertical signal lines 132-1 to 132-4, or a capacitive element connected to the vertical signal lines 132-1 to 132-4. In this case, the selection transistor 125 of each pixel 120 can be used as a sample-and-hold switch that causes the capacitance 133 to sample and hold the signals transmitted via the vertical signal lines 132-1 to 132-4 for each column.

In addition, a signal line reset transistor 141 is electrically connected to the vertical signal lines 132-1 to 132-4. The signal line reset transistor 141 can reset the potentials VSL1 to VSL4 of the vertical signal lines 132-1 to 132-4. Each signal line reset transistor 141 may be, for example, a MOS transistor. A signal line reset signal ΦRT is applied to the gate of each signal line reset transistor 141. The source of each signal line reset transistor 141 is connected to a reset potential VR. The reset potential VR may be set to a potential higher than the ground potential.

The signal readout circuit is also provided with an AD conversion unit that performs AD conversion on the signals transmitted via the vertical signal lines 132-1 to 132-4 for each column. The AD conversion unit is provided with a comparator 143 and a counter 146 for each column. Each comparator 143 compares the potentials VSL1 to VSL4 of the vertical signal lines 132-1 to 132-4 with a reference signal RAP for each column. The reference signal RAP may be a ramp signal. Each counter 146 performs a counting operation for each column based on the comparison result from each comparator 143.

The vertical signal lines 132-1 to 132-4 are connected to the inverting input of the comparator 143 via each DC-cut capacitor 144. When signals are individually read out from each pixel 120, the potentials VSL1 to VSL4 of the vertical signal lines 132-1 to 132-4 are applied to the inverting input of each comparator 143 via the DC-cut capacitor 144. When signals of different columns are binned and read out, the average value of the potentials VSL1 to VSL4 of the vertical signal lines 132-1 to 132-4 is applied to the inverting input of each comparator 143 via the DC-cut capacitor 144. The reference signal RAP is input to the non-inverting input of each comparator 143 via a DC-cut capacitor 145.

An auto-zero signal AZ is also input to each comparator 143. The auto-zero signal AZ activates an auto-zero operation during an auto-zero period. In the auto-zero operation, the charge stored in the DC-cut capacitors 144 and 145 can be controlled so that the non-inverting input and the inverting input of the comparator 143 are balanced.

A connection switch 151 is also provided in the signal readout circuit. The connection switch 151 connects the vertical signal lines 132-1 to 132-4 of different columns. At this time, the connection switch 151 is connected in series to the capacitance 133 for each column used for sampling and holding the signal read out from each pixel 120. Each connection switch 151 can be provided between the vertical signal lines 132-1 to 132-4 adjacent to each other in the row direction. Each connection switch 151 can be turned on/off based on the opening/closing signals ΦCn1 to ΦCn4, respectively.

Before reading out signals from each pixel 120, the signal line reset transistors 141 connected to the vertical signal lines 132-1 to 132-4 are turned on, and the potentials VSL1 to VSL4 of the vertical signal lines 132-1 to 132-4 are set to a potential higher than 0 V. Then, after the signal line reset transistors 141 connected to the vertical signal lines 132-1 to 132-4 are turned off, the selection transistors 125 of each pixel 120 are turned on, and a signal is read out from each pixel 120. At this time, the charges corresponding to the signal read out from each pixel 120 are stored in the capacitances 133 added to the vertical signal lines 132-1 to 132-4, respectively. The potentials VSL1 to VSL4 of the vertical signal lines 132-1 to 132-4 change based on the charges stored in the capacitances 133 added to the vertical signal lines 132-1 to 132-4, respectively.

Then, in the comparators 143 connected to the vertical signal lines 132-1 to 132-4, the potentials VSL1 to VSL4 of the vertical signal lines 132-1 to 132-4 are compared with the reference signal RAP, and the respective comparison results COP1 to COP4 are output. At this time, each comparator 143 can output the timing at which the potentials VSL1 to VSL4 of the vertical signal lines 132-1 to 132-4 match the level of the reference signal RAP as the comparison results COP1 to COP4 to each counter 146. Each counter 146 performs a counting operation based on the comparison results COP1 to COP4 from each comparator 143, and outputs a count value based on each counting operation.

On the other hand, when signals from each pixel 120 are binned and read out, the selection transistor 125 of each pixel 120 is turned off, and then the opening/closing signals ΦCn1 to ΦCn4 rise, connecting the vertical signal lines 132-1 to 132-4 to each other. At this time, the charges stored in the capacitances 133 added to the vertical signal lines 132-1 to 132-4 are binned, and the potentials VSL1 to VSL4 of the vertical signal lines 132-1 to 132-4 are averaged. Then, the average value of the potentials VSL1 to VSL4 of the vertical signal lines 132-1 to 132-4 is input to each comparator 143.

At this time, the active control unit 119 in FIG. 2 activates one of the comparators 143 and the counter 146 that perform AD conversion for each of the vertical signal lines 132-1 to 132-4. For example, the active control unit 119 may activate the comparator 143 and counter 146 provided corresponding to the vertical signal line 132-1 out of the comparators 143 and counters 146 provided corresponding to the vertical signal lines 132-1 to 132-4. At this time, the active control unit 119 can set the control signal CTL of the comparator 143 and counter 146 provided corresponding to the vertical signal line 132-1 to ACT. The active control unit 119 can also set the control signal CTL of the comparators 143 and counters 146 provided corresponding to the vertical signal lines 132-2 to 132-4 to STB. ACT can instruct activation, and STB can instruct standby.

Then, in the comparator 143 connected to the vertical signal line 132-1, the average value of the potentials VSL1 to VSL4 of the vertical signal lines 132-1 to 132-4 is compared with the reference signal RAP, and the comparison result COP1 is output. At this time, the comparator 143 connected to the vertical signal line 132-1 can output the timing at which the average value of the potentials VSL1 to VSL4 of the vertical signal lines 132-1 to 132-4 matches the level of the reference signal RAP as the comparison result COP1 to the counter 146. The counter 146 performs a counting operation based on the comparison result COP1 from the comparator 143, and outputs a count value based on the counting operation.

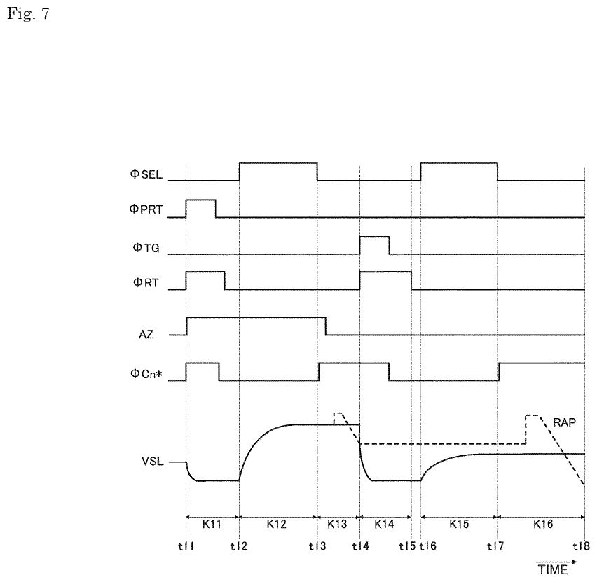

FIG. 7 is a diagram showing an example of the waveforms of each part when the imaging device according to the first embodiment reads out signals. Note that the FIGURE shows an example of the waveforms of each part when binning readout is performed. In addition, in the FIGURE, the potentials VSL1 to VSL4 of the vertical signal lines 132-1 to 132-4 and their average value are indicated by VSL.

In the FIGURE, in the capacitive load readout, pixel reset/VSL reset is performed (K11). At this time, the pixel reset signal ΦPRT of each pixel 120 rises (t11), the reset transistor 123 of each pixel 120 is turned on, and the floating diffusion 126 of each pixel 120 is reset. The reset level of the floating diffusion 126 of each pixel 120 can be set to the power supply potential Vdd. In addition, the signal line reset signal ΦRT rises (t11), the signal line reset transistors 141 connected to the vertical signal lines 132-1 to 132-4 are turned on, and the vertical signal lines 132-1 to 132-4 are reset. At this time, the reset level of the vertical signal lines 132-1 to 132-4 is set to the reset potential VR via the signal line reset transistor 141 connected to the vertical signal lines 132-1 to 132-4.

Furthermore, the opening/closing signal ΦCn* rises (t11), and a plurality of connection switches 151 connected to the vertical signal lines 132-1 to 132-4 are turned on. Note that the opening/closing signal ΦCn* indicates a plurality of opening/closing signals selected from the opening/closing signals ΦCn1 to ΦCn4. In the following explanation, the case where the opening/closing signal ΦCn* is the opening/closing signals ΦCn1 to ΦCn4 is taken as an example. At this time, the charges stored in the capacitances 133 added to the vertical signal lines 132-1 to 132-4 are equalized.

Then, the auto-zero signal AZ rises (t11), and the auto-zero operation of the comparator 143 connected to the vertical signal lines 132-1 to 132-4 is activated. At this time, the charges stored in the DC-cut capacitors 144 and 145 are controlled so that the non-inverting input and the inverting input of the comparator 143 connected to the vertical signal lines 132-1 to 132-4 are balanced. Then, the pixel reset signal ΦPRT falls, the opening/closing signal ΦCn* falls, and the signal line reset signal ΦRT falls.

Next, P-phase VSL settling/P-phase VSL sample-and-hold is performed (K12). At this time, the selection signal ΦSEL of each pixel 120 rises (t12), and the selection transistor 125 of each pixel 120 is turned on. Then, based on the source follower operation of the amplification transistor 124 of each pixel 120, the charge corresponding to the reset level of the floating diffusion 126 of each pixel 120 is stored in the capacitance 133 added to the vertical signal lines 132-1 to 132-4. Then, the potentials VSL1 to VSL4 of the vertical signal lines 132-1 to 132-4 are set based on the charge stored in the capacitance 133 added to the vertical signal lines 132-1 to 132-4.

Next, P-phase binning/P-phase AD is performed (K13). At this time, after the selection signal ΦSEL of each pixel 120 falls (t13), the opening/closing signal ΦCn* rises and the auto-zero signal AZ falls. When the opening/closing signal ΦCn* rises, the connection switch 151 connected to the vertical signal lines 132-1 to 132-4 is turned on. Then, the charge stored in the capacitance 133 added to the vertical signal lines 132-1 to 132-4 is binned, and the potentials VSL1 to VSL4 of the vertical signal lines 132-1 to 132-4 are averaged. Then, the average value of the potentials VSL1 to VSL4 of the vertical signal lines 132-1 to 132-4 is input to each comparator 143. In addition, for example, among the comparators 143 and counters 146 provided corresponding to the vertical signal lines 132-1 to 132-4, only the comparator 143 and counter 146 provided corresponding to the vertical signal line 132-1 are activated. The activated comparator 143 is supplied with a ramp signal as the reference signal RAP. Then, in the activated comparator 143, the average value of the potentials VSL1 to VSL4 of the vertical signal lines 132-1 to 132-4 corresponding to the reset level is compared with the reference signal RAP. Then, the timing when the level of the reference signal RAP matches the average value of the potentials VSL1 to VSL4 of the vertical signal lines 132-1 to 132-4 is output as the comparison result COP1. At this time, in the activated counter 146, a counting operation is performed until the level of the reference signal RAP matches the average value of the potentials VSL1 to VSL4 of the vertical signal lines 132-1 to 132-4. Then, based on the counting operation of the activated counter 146, the average value of the reset levels read from each pixel 120 connected to the vertical signal lines 132-1 to 132-4 is AD-converted.

Next, transfer/VSL reset is performed (K14). At this time, the transfer signal ΦTG of each pixel 120 rises (t14), the transfer transistor 122 of each pixel 120 is turned on, and the charge stored in the photodiode 121 of each pixel 120 is transferred to the floating diffusion 126 of each pixel 120. In addition, the signal line reset signal ΦRT rises (t14), and the signal line reset transistors 141 connected to the vertical signal lines 132-1 to 132-4 are turned on, and the vertical signal lines 132-1 to 132-4 is reset. At this time, the reset level of the vertical signal lines 132-1 to 132-4 is set to the reset potential VR via the signal line reset transistor 141 connected to the vertical signal lines 132-1 to 132-4. Then, the transfer signal ΦTG falls, the opening/closing signal ΦCn* falls, and the signal line reset signal ΦRT falls (t15).

Next, D-phase VSL settling/D-phase VSL sample-and-hold is performed (K15). At this time, the selection signal ΦSEL rises (t16), and the selection transistor 125 of each pixel 120 is turned on. Then, the charges corresponding to the signal level of the floating diffusion 126 of each pixel 120 are stored in the capacitances 133 added to the vertical signal lines 132-1 to 132-4 based on the source follower operation of the amplification transistor 124 of each pixel 120. Then, the potentials VSL1 to VSL4 of the vertical signal lines 132-1 to 132-4 are set based on the charge stored in the capacitance 133 added to the vertical signal lines 132-1 to 132-4.

Next, D-phase binning/D-phase AD is performed (K16). At this time, after the selection signal ΦSEL falls (t17), the opening/closing signal ΦCn* rises. When the opening/closing signal ΦCn* rises, the connection switch 151 connected to the vertical signal lines 132-1 to 132-4 is turned on. Then, the charges stored in the capacitances 133 added to the vertical signal lines 132-1 to 132-4 are binned, and the potentials VSL1 to VSL4 of the vertical signal lines 132-1 to 132-4 are averaged. Then, the average value of the potentials VSL1 to VSL4 of the vertical signal lines 132-1 to 132-4 is input to each comparator 143. The activated comparator 143 is also supplied with a ramp signal as the reference signal RAP. The activated comparator 143 compares the average value of the potentials VSL1 to VSL4 of the vertical signal lines 132-1 to 132-4 corresponding to the signal level with the reference signal RAP. Then, the timing when the level of the reference signal RAP matches the average value of the potentials VSL1 to VSL4 of the vertical signal lines 132-1 to 132-4 is output as a comparison result COP1. At this time, the activated counter 146 performs a counting operation until the level of the reference signal RAP matches the average value of the potentials VSL1 to VSL4 of the vertical signal lines 132-1 to 132-4. Then, based on the counting operation of the activated counter 146, the average value of the signal levels read out from each pixel 120 connected to the vertical signal lines 132-1 to 132-4 is AD-converted.

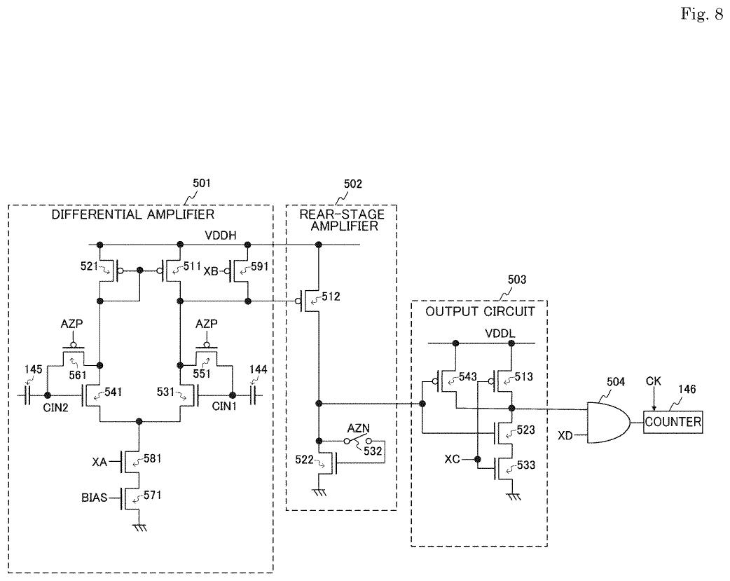

FIG. 8 is a diagram showing an example of the configuration of a comparator applied to a signal readout circuit according to the first embodiment.

In the FIGURE, the comparator 143 includes a differential amplifier 501, a rear-stage amplifier 502, an output circuit 503, and an AND circuit 504. The rear-stage amplifier 502 is connected to the rear stage of the differential amplifier 501, and the output circuit 503 is connected to the rear stage of the rear-stage amplifier 502. The AND circuit 504 is connected to the rear stage of the output circuit 503, and the counter 146 is connected to the rear stage of the AND circuit 504.

The differential amplifier 501 balances the comparator inputs CIN1 and CIN2 based on the auto-zero operation, and outputs a voltage according to the difference between the comparator inputs CIN1 and CIN2. The differential amplifier 501 includes PMOS transistors 511, 521, 551, 561, and 591, and NMOS transistors 531, 541, 571, and 581.

The PMOS transistor 511 and the NMOS transistor 531 are connected in series to each other. The PMOS transistor 521 and the NMOS transistor 541 are connected in series to each other. The sources of the PMOS transistors 511 and 521 are connected to the power supply voltage VDDH, and the gates of the PMOS transistors 511 and 521 are connected to the drain of the PMOS transistor 521. In this case, the PMOS transistors 511 and 521 can form a current mirror. The PMOS transistor 591 is connected in parallel to the PMOS transistor 511.

The PMOS transistor 551 is connected between the gate and drain of the NMOS transistor 531, and the PMOS transistor 561 is connected between the gate and drain of the NMOS transistor 541. The NMOS transistors 571 and 581 are connected in series to each other. The sources of the NMOS transistors 531 and 541 are grounded via the series circuit of the NMOS transistors 571 and 581.

An auto-zero signal AZP is applied to the gates of the PMOS transistors 551 and 561, and a bias voltage BIAS is applied to the gate of the NMOS transistor 571. The NMOS transistor 571 can operate as a constant current source based on the bias voltage BIAS. A control signal XA is applied to the gate of the NMOS transistor 581. A control signal XB is applied to the gate of the PMOS transistor 591.

The rear-stage amplifier 502 amplifies the output of the differential amplifier 501. The rear-stage amplifier 502 includes a PMOS transistor 512, an NMOS transistor 522, and a switch 532.

The PMOS transistor 512 and the NMOS transistor 522 are connected in series to each other. The source of the PMOS transistor 512 is connected to the power supply voltage VDDH, and the gate of the PMOS transistor 512 is connected to the drain of the PMOS transistor 511. A switch 532 is connected between the gate and drain of the NMOS transistor 522, and the source of the NMOS transistor 522 is grounded. The switch 532 opens and closes based on the auto-zero signal AZN.

The output circuit 503 converts the output of the rear-stage amplifier 502 to a logical value ‘0’ or a logical value ‘1’. The output circuit 503 includes PMOS transistors 513 and 543, and NMOS transistors 523 and 533.

The PMOS transistor 513 and the NMOS transistor 523 are connected in series to each other, and the NMOS transistors 523 and 533 are connected in series to each other. The sources of the PMOS transistors 513 and 543 are connected to the power supply voltage VDDL, and the source of the NMOS transistor 533 is grounded. The drain of the PMOS transistor 543 is connected to the drain of the PMOS transistor 513. The power supply voltage VDDL can be lower than the power supply voltage VDDH. The gate of the PMOS transistor 543 and the gate of the NMOS transistor 523 are connected to the drain of the PMOS transistor 512. A control signal XC is applied to the gate of the PMOS transistor 513 and the gate of the NMOS transistor 533.

The first input terminal of the AND circuit 504 is connected to the drain of the PMOS transistor 513. A control signal XD is applied to the second input terminal of the AND circuit 504. The control signals XA, XB, XC, and XD are input to the comparator 143 as the control signal CTL in FIG. 6.

When the comparator 143 is set to the standby state, the control signals XA, XB, XC, and XD are set to a low level. At this time, the NMOS transistors 533 and 581 are turned off, the PMOS transistors 512 and 513 are turned on, and the logical value ‘O’ is output from the AND circuit 504.

When the comparator 143 is set to the active state, the control signals XA, XB, XC, and XD are set to a high level. At this time, the NMOS transistors 533 and 581 are turned on, the PMOS transistors 512 and 513 are turned off, and the AND circuit 504 outputs a logical value of ‘0’ or ‘1’ according to the output from the output circuit 503.

At this time, during the auto-zero period, the PMOS transistors 551 and 561 are turned on based on the auto-zero signal AZP, and the switch 532 is closed based on the auto-zero signal AZN. Note that the timing at which the PMOS transistors 551 and 561 are turned on and then off can be delayed compared to the timing at which the switch 532 is closed and then opened. At this time, a current flows through the PMOS transistors 551 and 561 based on the current mirror operation of the PMOS transistors 511 and 521. Then, charges are stored in the DC-cut capacitors 144 and 145 so that the non-inverting input and the inverting input of the comparator 143 are balanced.

In this way, in the first embodiment described above, the signal line reset transistor 141 performs binning based on the signal sampled and held for each column connected to the vertical signal lines 132-1 to 132-4. As a result, it is possible to perform binning in the column direction while suppressing an increase in the area of the signal readout circuit, and ensure linearity during binning without limiting the number of binnings.

In addition, by activating the AD conversion unit provided for each of the vertical signal lines 132-1 to 132-4, it is possible to set the AD conversion unit that does not need to operate during binning processing to a standby state, thereby achieving low power consumption.

In addition, by resetting the vertical signal line 132 when reading out signals from each pixel 120, the charges corresponding to the pixel current flowing when reading out signals from each pixel 120 can be stored in the capacitance 133. Therefore, it is no longer necessary to pass a constant current corresponding to the signal read from each pixel 120 via the vertical signal lines 132-1 to 132-4 in order to detect the signal read from each pixel 120, and the current consumption when reading out signals from each pixel 120 can be reduced.

### 2. Second Embodiment

In the above-mentioned first embodiment, the signal line reset transistor 141 performs binning based on the signal sampled and held for each column connected to the vertical signal lines 132-1 to 132-4. In this second embodiment, the diode-connected transistor performs binning based on the signal sampled and held for each column connected to the vertical signal lines 132-1 to 132-4 via the signal line reset transistor 141.

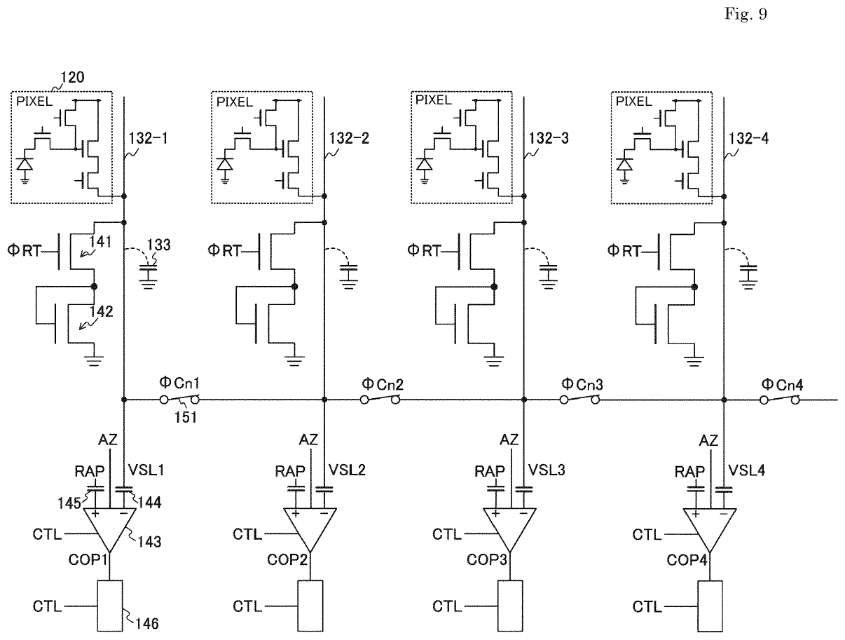

FIG. 9 is a diagram showing an example of the configuration of a signal readout circuit for four columns according to the second embodiment.

In the FIGURE, this signal readout circuit is obtained by adding a diode-connected transistor 142 to the signal readout circuit of the first embodiment described above. The other configurations of the signal readout circuit of the second embodiment are similar to those of the signal readout circuit of the first embodiment described above.

The diode-connected transistor 142 is connected in series to the signal line reset transistor 141 for each of the vertical signal lines 132-1 to 132-4. The diode-connected transistor 142 may be, for example, a MOS transistor. At this time, the gate of the diode-connected transistor 142 is connected to the drain of the diode-connected transistor 142. The source of the diode-connected transistor 142 is grounded. The source of the diode-connected transistor 142 may be connected to a potential higher than the ground potential. The diode-connected transistor 142 generates a voltage higher than 0 V (for example, 0.5 V) and can set the potentials VSL1 to VSL4 of the vertical signal lines 132-1 to 132-4 to a potential higher than 0 V via the signal line reset transistor 141. The diode-connected transistor 142 is an example of a signal line reset level generating unit described in the claims. The operation of the signal readout circuit of the second embodiment during binning is similar to the operation of the signal readout circuit of the first embodiment during binning.

In this way, in the above-mentioned second embodiment, the diode-connected transistor 142 performs binning based on the signal sampled and held for each column connected to the vertical signal lines 132-1 to 132-4 via the signal line reset transistor 141. In this way, when the vertical signal lines 132-1 to 132-4 are reset, the potentials of the vertical signal lines 132-1 to 132-4 can be raised according to the forward voltage of the diode-connected transistor 142.

Therefore, the potentials of the vertical signal lines 132-1 to 132-4 at the start of P-phase VSL settling can be made higher than 0 V, and the settling time can be shortened.

### 3. Third Embodiment

In the above-mentioned first embodiment, binning is performed based on the signal sampled and held for each column, and the connection switch 151 is connected in series to the capacitance 133 for each column used for sampling-and-holding. In this third embodiment, binning is performed based on the signal sampled and held for each column, and the connection switch is connected in parallel to the capacitance for each column used for sampling-and-holding.

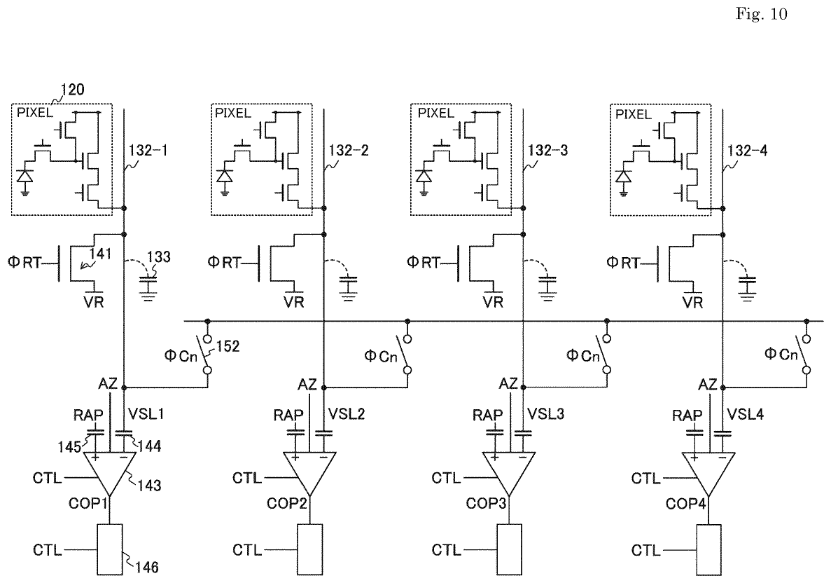

FIG. 10 is a diagram showing an example of the configuration of a signal readout circuit for four columns according to the third embodiment.

In the FIGURE, this signal readout circuit has a connection switch 152 instead of the connection switch 151 of the signal readout circuit of the above-mentioned first embodiment. The other configurations of the signal readout circuit of the third embodiment are similar to those of the signal readout circuit of the above-mentioned first embodiment.

The connection switch 152 connects the vertical signal lines 132-1 to 132-4 of different columns. At this time, the connection switch 152 is connected in parallel to the capacitance 133 for each column used for sampling and holding the signal read out from each pixel 120. Each connection switch 152 can be turned on/off based on the opening/closing signal ΦCn. When the connection switch 152 is used, the number of binnings in the column direction is fixed. The operation of the signal readout circuit of this third embodiment during binning is similar to the operation of the signal readout circuit of the first embodiment during binning, except that the number of binnings in the column direction is fixed.

As described above, in the above-mentioned third embodiment, the signal line reset transistor 141 performs binning based on the signal sampled and held for each column connected to the vertical signal lines 132-1 to 132-4. As a result, it is possible to perform binning in the column direction while suppressing an increase in the area of the signal readout circuit, and to ensure linearity during binning without limiting the number of binnings.

### 4. Fourth Embodiment

In the first embodiment described above, binning is performed in the column direction based on the signal sampled and held for each column. In the fourth embodiment, binning is performed in the column and row directions based on the signal sampled and held for each column.

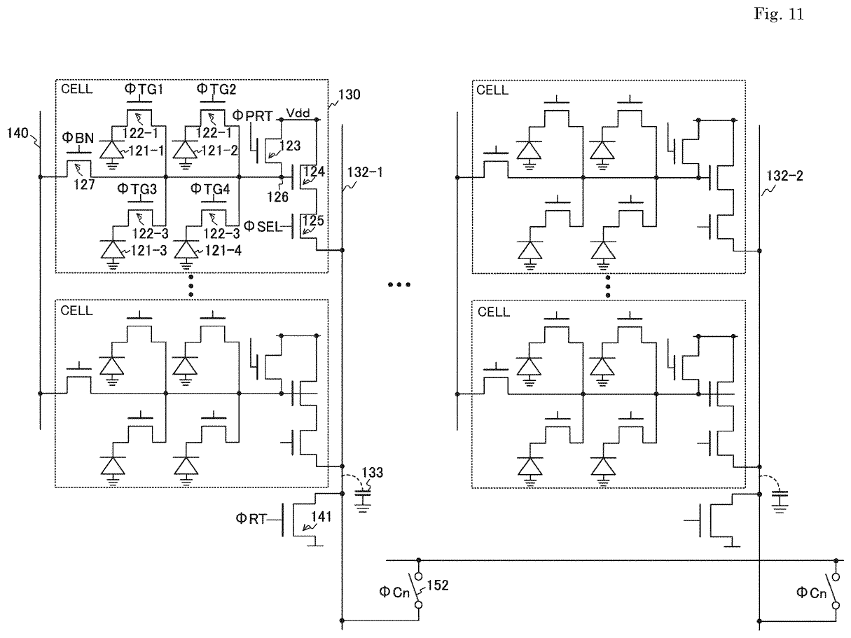

FIG. 11 is a diagram showing an example of the configuration of a signal readout circuit for two columns according to the fourth embodiment.

In the FIGURE, this signal readout circuit has cells 130 instead of the pixels 120 of the signal readout circuit of the first embodiment described above. In addition, this signal readout circuit has binning lines 140 added to the signal readout circuit of the first embodiment described above. The other configurations of the signal readout circuit of the fourth embodiment are similar to those of the signal readout circuit of the first embodiment described above.

The cells 130 are arranged in a matrix in the row and column directions. The cells 130 are connected to the vertical signal lines 132-1 and 132-2 for each column. Instead of the photodiode 121 and transfer transistor 122 of the first embodiment described above, the cell 130 includes photodiodes 121-1 to 121-4, transfer transistors 122-1 to 122-4, and a binning transistor 127. The other configurations of the cell 130 of the fourth embodiment are similar to those of the pixel 120 of the first embodiment described above.

The photodiodes 121-1 to 121-4 can be arranged in two rows and two columns. The photodiodes 121-1 to 121-4 are connected to the floating diffusion 126 via the transfer transistors 122-1 to 122-4, respectively. Transfer signals ΦTG1 to ΦTG4 are applied to the gates of the transfer transistors 122-1 to 122-4. By controlling the application timing of the transfer signals ΦTG1 to ΦTG4, signals may be read out individually from the photodiodes 121-1 to 121-4, or signals may be read out by binning from the photodiodes 121-1 to 121-4. The capacitive load readout operation for the photodiodes 121-1 to 121-4 is similar to the capacitive load readout operation for the photodiode 121 in the first embodiment described above.

The binning transistor 127 is connected between the floating diffusion 126 and the binning line 140 for each cell 130. The binning transistor 127 may be a MOS transistor. A binning signal PBN is applied to the gate of the binning transistor 127 for each cell 130.

When reading out signals from each cell 130 individually, the binning signal ΦBN is set to a low level, and the binning transistor 127 of each cell 130 is turned off.

On the other hand, when reading out signals from each cell 130 by binning in the row direction, the binning signal ΦBN is set to a high level, and the binning transistor 127 of each cell 130 is turned on. The operation of the signal readout circuit of the fourth embodiment during binning in the row and column directions is similar to the operation of the signal readout circuit of the first embodiment during binning, except that the binning transistor 127 of each cell 130 is turned on.

For example, suppose that the signals of the photodiodes 121-1 to 121-4 are averaged for 32 rows×2 columns, and the signals of the cells 130 for 16 columns are averaged capacitively. At this time, the number of columns of the AD conversion units that are activated can be 1/16 of that for all-pixel individual readout, and power consumption can be reduced.

In this way, in the above-mentioned fourth embodiment, each cell 130 is provided with a binning transistor 127 that connects the cells 130 of different rows to each other. This allows binning not only in the column direction but also in the row direction, making it possible to increase the number of binnings while suppressing a decrease in spatial resolution in the row direction.

### 5. Fifth Embodiment

In the above-mentioned first embodiment, the average value of the signals sampled and held for each column connected to the vertical signal lines 132-1 to 132-4 is input to the comparator 143. In the fifth embodiment, the average value of the signal sampled and held for each column connected to the vertical signal lines 132-1 to 132-4 is input to the comparator 143 via the amplifier 161.

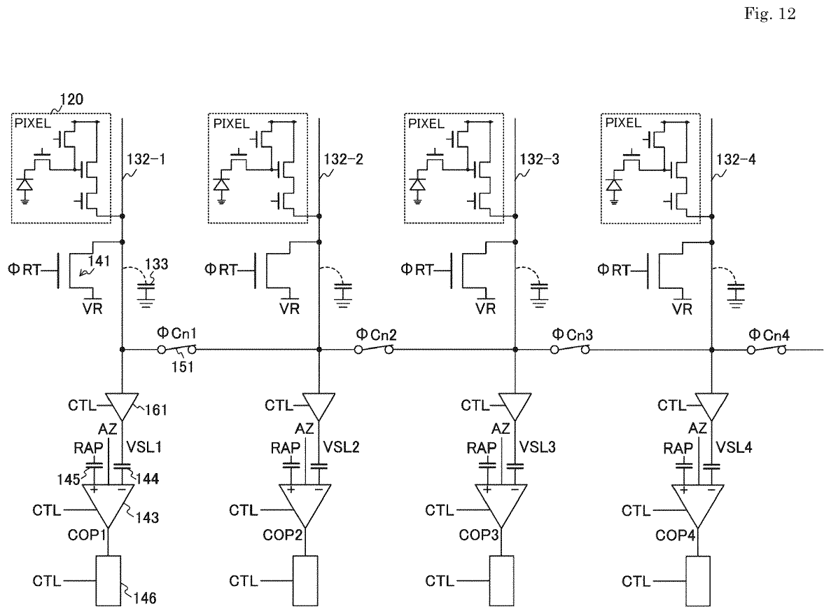

FIG. 12 is a diagram showing an example of the configuration of a signal readout circuit for four columns according to the fifth embodiment.

In the FIGURE, this signal readout circuit is obtained by adding an amplifier 161 to the signal readout circuit of the first embodiment described above. The other configurations of the signal readout circuit of the fifth embodiment are similar to those of the signal readout circuit of the first embodiment described above.

The amplifier 161 amplifies the signal transmitted to the comparator 143 via the vertical signal lines 132-1 to 132-4 for each column. An amplifier 161 is provided for each of the vertical signal lines 132-1 to 132-4. Each amplifier 161 is connected to the inverting input terminal of each comparator 143 via a DC-cut capacitor 144. A control signal CTL is input to the amplifier 161. At this time, the amplifier 161 in the same column as the comparator 143 and the counter 146 can be activated in response to their activation. In addition, the amplifier 161 in the same column as the comparator 143 and the counter 146 can be set to a standby state in response to the standby state of the comparator 143 and the counter 146.

As described above, in the above-mentioned fifth embodiment, an amplifier 161 is provided for each of the vertical signal lines 132-1 to 132-4, and a control signal CTL is input to each amplifier 161. As a result, it is possible to amplify the signal transmitted to the comparator 143 while suppressing an increase in power consumption during binning.

### 6. Sixth Embodiment

In the above-mentioned third embodiment, the selection transistor 125 is used as a sample-and-hold switch that samples and holds the signals transmitted via the vertical signal lines 132-1 to 132-4 for each column. In the sixth embodiment, a sample-and-hold switch that samples and holds the signals transmitted via the vertical signal lines 132-1 to 132-4 for each column is provided on the vertical signal lines 132-1 to 132-4.

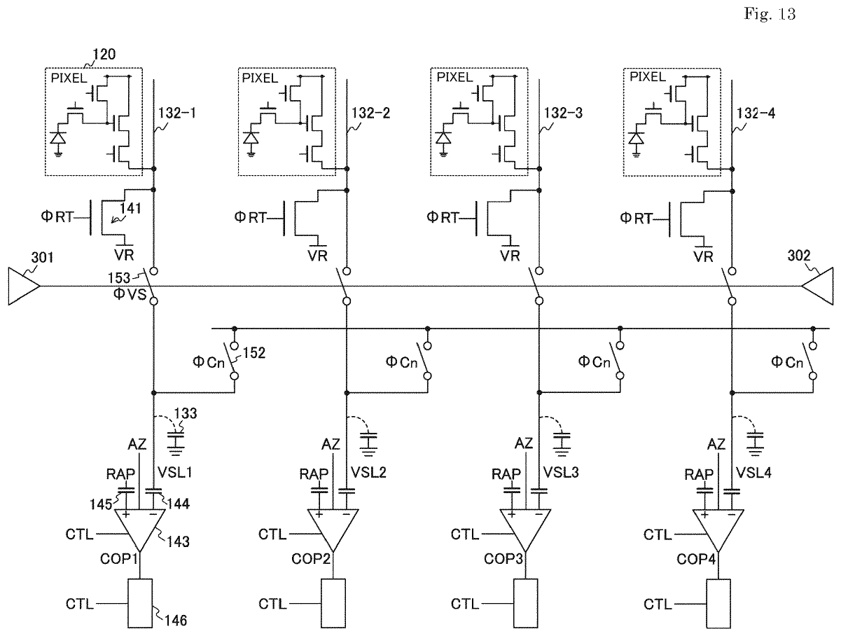

FIG. 13 is a diagram showing an example of the configuration of a signal readout circuit for four columns according to the sixth embodiment.

In the FIGURE, this signal readout circuit is obtained by adding a sample-and-hold switch 153 and drivers 301 and 302 to the signal readout circuit of the third embodiment described above. The other configurations of the signal readout circuit of the sixth embodiment are similar to those of the signal readout circuit of the third embodiment described above.

The sample-and-hold switch 153 samples and holds the signals transmitted via the vertical signal lines 132-1 to 132-4 in each capacitance 153 for each column. The sample-and-hold switch 153 is provided for each of the vertical signal lines 132-1 to 132-4. Each sample-and-hold switch 153 is turned on/off based on the sample-and-hold signal ΦVS. Each sample-and-hold switch 153 may be a MOS transistor.

The drivers 301 and 302 drive the sample-and-hold switch 153 from both sides in the row direction. The drivers 301 and 302 can be shared by the sample-and-hold switch 153 provided for each column.

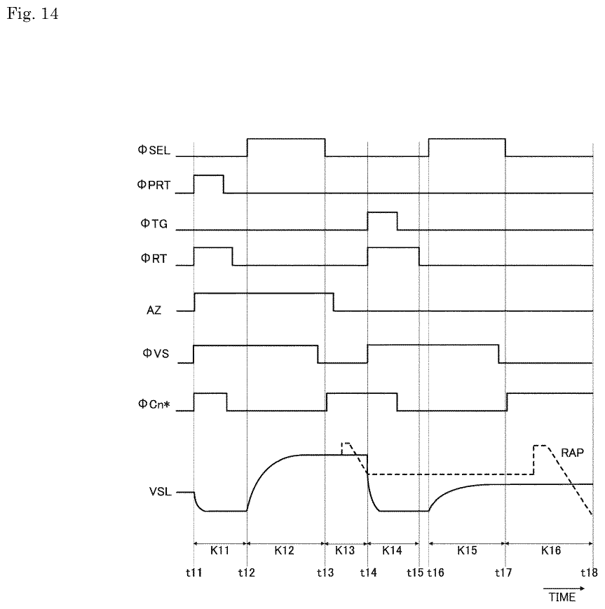

FIG. 14 is a diagram showing an example of waveforms of each part when reading out signals in an imaging device according to the sixth embodiment. Note that the FIGURE shows an example of waveforms of each part when reading out signals by binning.

In the FIGURE, the operation during the binning readout in the sixth embodiment is similar to the operation during the binning readout in the first embodiment described above, except that a sample-and-hold signal PVS is added.

The sample-and-hold signal ΦVS rises (t11) simultaneously with the rise of the pixel reset signal ΦPRT in pixel reset/VSL reset (K11). In addition, the sample-and-hold signal DVS falls before the selection signal ΦSEL falls in P-phase VSL settling/P-phase VSL sample-and-hold (K12).

Furthermore, the sample-and-hold signal ΦVS rises (t14) simultaneously with the rise of the transfer signal ΦTG in transfer/VSL reset (K14). In addition, the sample-and-hold signal DVS falls before the selection signal ΦSEL falls in D-phase VSL settling/D-phase VSL sample-and-hold (K15).

In this way, in the sixth embodiment described above, a sample-and-hold switch 153 is provided that samples and holds the signals transmitted via the vertical signal lines 132-1 to 132-4 for each column. As a result, it is possible to perform binning in the column direction while ensuring linearity during binning.

In addition, the drivers 301 and 302 are provided that drive the sample-and-hold switch 153 from both sides in the row direction. As a result, it is possible to increase the driving force of the sample-and-hold switch 153 for each column without providing the drivers 301 and 302 for driving the sample-and-hold switch 153 for each row. As a result, it is possible to reduce the in-plane difference in driving force, making it possible to reduce fixed pattern noise, and also suppressing an increase in the area required for the arrangement of the drivers 301 and 302.

### 7. Seventh Embodiment

In the first embodiment described above, for the activated and deactivated columns, the potentials VSL1 to VSL4 of the vertical signal lines 132-1 to 132-4 are input to the comparators 143 via the DC-cut capacitors 144. In the seventh embodiment, for the deactivated columns, the connection destination of the DC-cut capacitor 144 is switched from the comparator input to the ground.

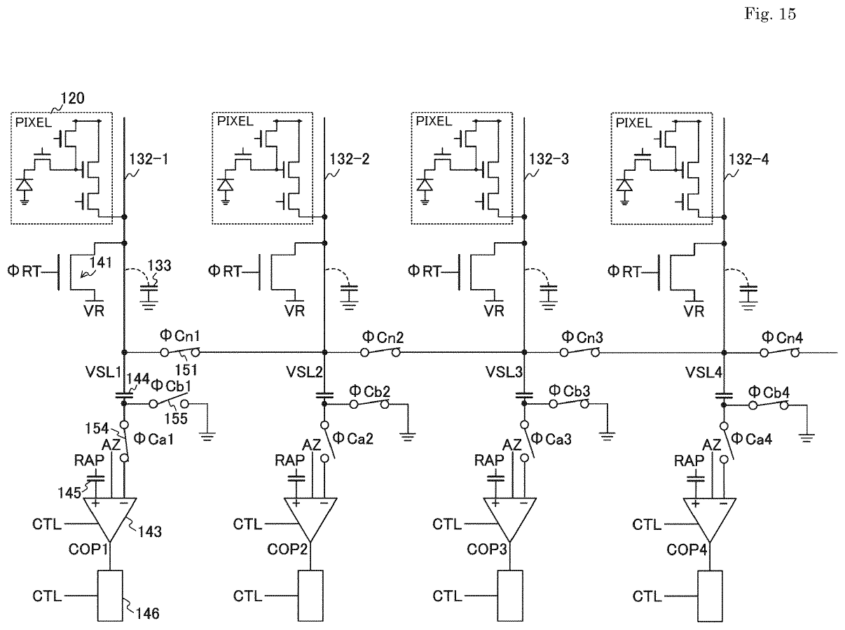

FIG. 15 is a diagram showing an example of the configuration of a signal readout circuit for four columns according to the seventh embodiment.

In the FIGURE, this signal readout circuit is obtained by adding switches 154 and 155 to the signal readout circuit of the first embodiment described above. The other configurations of the signal readout circuit of the seventh embodiment are similar to those of the signal readout circuit of the first embodiment described above.

The first capacitance electrodes of the DC-cut capacitors 144 of each column are connected to the vertical signal lines 132-1 to 132-4. The changeover switches 154 and 155 are provided for each column. The changeover switch 154 is connected between the second capacitance electrode of the DC-cut capacitor 144 of each column and the inverting input terminal of each comparator 143. The changeover switch 155 is connected between the second capacitance electrode of the DC-cut capacitor 144 of each column and ground.

Then, for an activated column, the changeover switch 154 is turned on and the changeover switch 155 is turned off. On the other hand, for a deactivated column, the changeover switch 154 is turned off and the changeover switch 155 is turned on. At this time, the changeover switches 154 and 155 are controlled separately for the activated column and the deactivated column.

For example, among the comparators 143 and counters 146 provided corresponding to the vertical signal lines 132-1 to 132-4, the comparator 143 and counter 146 provided corresponding to the vertical signal line 132-1 are activated. At this time, the changeover switch 154 connected to the vertical signal line 132-1 is turned on, and the changeover switch 155 is turned off. On the other hand, the changeover switches 154 connected to the vertical signal lines 132-2 to 132-4 are turned off, and the changeover switch 155 is turned on. In addition, during binning, the opening/closing signals ΦCn1 to ΦCn4 are turned on. As a result, the capacitance of the DC-cut capacitors 144 connected to the vertical signal lines 132-2 to 132-4 is added to the capacitance 133 of the vertical signal line 132-1.

In this way, in the seventh embodiment described above, for a deactivated column, the connection destination of the DC-cut capacitor 144 is switched from the comparator input to the ground. As a result, it is possible to increase the capacitance added to the vertical signal line 132-1 of the activated column, thereby reducing kTC noise.

### 8. Eighth Embodiment

In the first embodiment described above, binning is performed based on capacitive load readout. In the eighth embodiment, binning is performed based on constant current readout.

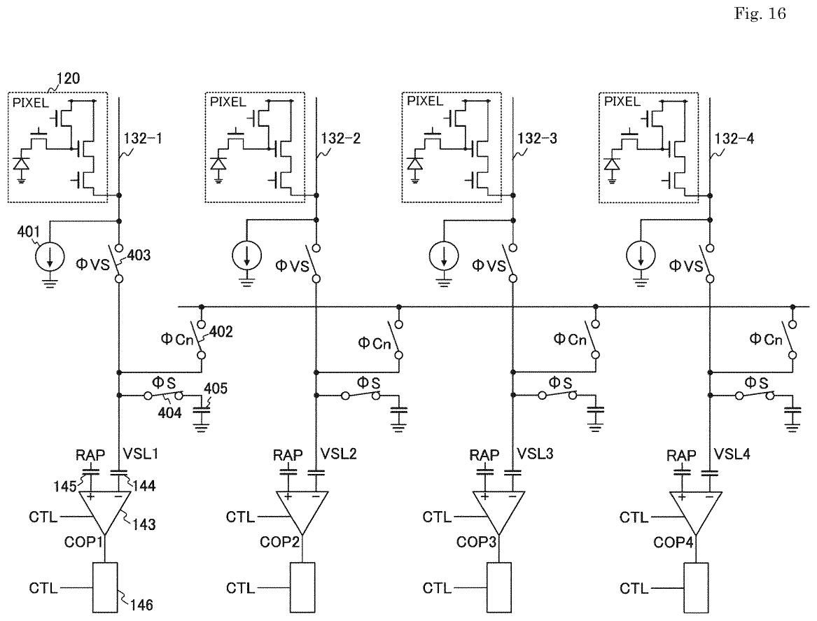

FIG. 16 is a diagram showing an example of the configuration of a signal readout circuit for four columns according to the eighth embodiment.

In the FIGURE, this signal readout circuit has a current source 401 instead of the signal line reset transistor 141 of the signal readout circuit of the first embodiment described above. In addition, this signal readout circuit has a connection switch 402, sample-and-hold switches 403 and 404, and a capacitance 405 added to the signal readout circuit of the first embodiment described above. The other configurations of the signal readout circuit of the eighth embodiment are similar to those of the signal readout circuit of the first embodiment described above.

A current source 401 can be provided for each column. Each current source 401 is connected to the vertical signal lines 132-1 to 132-4. The current source 401 may be a MOS transistor.

The sample-and-hold switches 403 and 404 cause the capacitance 405 to sample and hold the signals transmitted via the vertical signal lines 132-1 to 132-4 for each column. The sample-and-hold switches 403 and 404 are provided for each of the vertical signal lines 132-1 to 132-4. At this time, each sample-and-hold switch 403 is connected in series to each of the vertical signal lines 132-1 to 132-4. The sample-and-hold switch 404 is connected between the vertical signal lines 132-1 to 132-4 and the capacitance 405. The sample-and-hold switch 403 is turned on/off based on the sample-and-hold signal ΦVS. The sample-and-hold switch 404 is turned on/off based on the sample-and-hold signal ΦS. The sample-and-hold switches 403 and 404 may be a MOS transistor.

The capacitance 405 can be provided for each column. Each capacitance 405 is connected to each of the vertical signal lines 132-1 to 132-4 via a sample-and-hold switch 404. The capacitance 405 can be used for sampling and holding signals read out from each pixel 120 for each column.

The connection switch 402 connects the vertical signal lines 132-1 to 132-4 of different columns. At this time, the connection switch 402 is connected in parallel to the capacitance 405 for each column used for sampling and holding signals read out from each pixel 120. Each connection switch 402 may be a MOS transistor. Each connection switch 402 is turned on/off based on an opening/closing signal ΦCn.

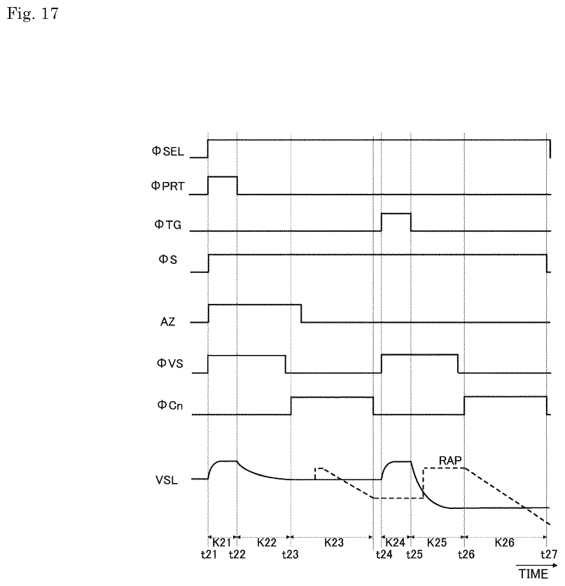

FIG. 17 is a diagram showing an example of waveforms of each part during signal readout of the imaging device according to the eighth embodiment. Note that the FIGURE shows an example of waveforms of each part during the binning readout.

In the FIGURE, in the constant current readout, pixel reset is performed (K21). At this time, the pixel reset signal ΦPRT of each pixel 120 rises (t21), the reset transistor 123 of each pixel 120 is turned on, and the floating diffusion 126 of each pixel 120 is reset. In addition, the selection signal SEL of each pixel 120 rises (t21), and the selection transistor 125 of each pixel 120 is turned on. At this time, the potentials VSL1 to VSL4 of the vertical signal lines 132-1 to 132-4 are set based on the source follower operation when the power supply potential Vdd is applied to the gate of the amplification transistor 124 of each pixel 120.

In addition, the sample-and-hold signal ΦS rises (t21), and the sample-and-hold switches 404 connected to the vertical signal lines 132-1 to 132-4 are turned on. At this time, the capacitances 405 provided for each column are connected to the vertical signal lines 132-1 to 132-4 via the sample-and-hold switches 404.

Then, the sample-and-hold signal ΦVS rises (t21), and the sample-and-hold switches 403 connected to the vertical signal lines 132-1 to 132-4 are turned on. At this time, the capacitances 405 provided for each column are connected to the pixels 120 for each column via the vertical signal lines 132-1 to 132-4.

Then, the auto-zero signal AZ rises (t21), and the auto-zero operation of the comparators 143 connected to the vertical signal lines 132-1 to 132-4 is activated. At this time, the charges stored in the DC-cut capacitors 144 and 145 are controlled so that the non-inverting input and the inverting input of the comparators 143 connected to the vertical signal lines 132-1 to 132-4 are balanced.

Next, P-phase VSL settling/P-phase VSL sample-and-hold are performed (K22). At this time, the pixel reset signal ΦPRT of each pixel 120 falls (t22), and the reset transistor 123 of each pixel 120 is turned off. Then, the potentials VSL1 to VSL4 of the vertical signal lines 132-1 to 132-4 are set based on the source follower operation when the reset level of the floating diffusion 126 of each pixel 120 is applied to the gate of the amplification transistor 124 of each pixel 120. Then, the charges corresponding to the potentials VSL1 to VSL4 of the vertical signal lines 132-1 to 132-4 are sampled and held in the capacitance 405 for each column. Then, the sample-and-hold signal VS falls.

Next, P-phase binning/P-phase AD is performed (K23). At this time, the opening/closing signal ΦCn rises (t23), and the auto-zero signal AZ falls. When the opening/closing signal ΦCn rises, the connection switches 402 connected to the vertical signal lines 132-1 to 132-4 are turned on. Then, the charges stored in the capacitances 405 added to the vertical signal lines 132-1 to 132-4 are binned, and the potentials VSL1 to VSL4 of the vertical signal lines 132-1 to 132-4 are averaged. Then, the average value of the potentials VSL1 to VSL4 of the vertical signal lines 132-1 to 132-4 is input to each comparator 143. In addition, for example, among the comparators 143 and counters 146 provided corresponding to the vertical signal lines 132-1 to 132-4, only the comparator 143 and counter 146 provided corresponding to the vertical signal line 132-1 are activated. In addition, a ramp signal is supplied as a reference signal RAP to the activated comparator 143. Then, in the activated comparator 143, the average value of the potentials VSL1 to VSL4 of the vertical signal lines 132-1 to 132-4 corresponding to the reset level is compared with the reference signal RAP. Then, the timing when the level of the reference signal RAP matches the average value of the potentials VSL1 to VSL4 of the vertical signal lines 132-1 to 132-4 is output as the comparison result COP1. At this time, in the activated counter 146, a counting operation is performed until the level of the reference signal RAP matches the average value of the potentials VSL1 to VSL4 of the vertical signal lines 132-1 to 132-4. Then, based on the counting operation of the activated counter 146, the average value of the reset levels read out from each pixel 120 connected to the vertical signal lines 132-1 to 132-4 is AD-converted. After that, the opening/closing signal ΦCn falls.

Next, transfer is performed (K24). At this time, the transfer signal ΦTG of each pixel 120 rises (t24), the transfer transistor 122 of each pixel 120 is turned on, and the charge stored in the photodiode 121 of each pixel 120 is transferred to the floating diffusion 126 of each pixel 120. In addition, the potentials VSL1 to VSL4 of the vertical signal lines 132-1 to 132-4 are set based on the source follower operation when the cathode potential of the photodiode 121 of each pixel 120 is applied to the gate of the amplification transistor 124 of each pixel 120.

In addition, the sample-and-hold signal DVS rises (t24), and the sample-and-hold switches 403 connected to the vertical signal lines 132-1 to 132-4 are turned on. At this time, the capacitance 405 provided for each column is connected to the pixel 120 for each column via the vertical signal lines 132-1 to 132-4.

Next, D-phase VSL settling/D-phase VSL sample-and-hold is performed (K25). At this time, the transfer signal ΦTG of each pixel 120 falls (t25), and the transfer transistor 122 of each pixel 120 is turned off. Then, the potentials VSL1 to VSL4 of the vertical signal lines 132-1 to 132-4 are set based on the source follower operation when the signal level of the floating diffusion 126 of each pixel 120 is applied to the gate of the amplification transistor 124 of each pixel 120. Then, the charges corresponding to the potentials VSL1 to VSL4 of the vertical signal lines 132-1 to 132-4 are sampled and held in the capacitance 405 for each column. Then, the sample-and-hold signal DVS falls.

Next, D-phase binning/P-phase AD is performed (K26). At this time, the opening/closing signal ΦCn rises (t26), and the connection switches 402 connected to the vertical signal lines 132-1 to 132-4 are turned on. Then, the charges stored in the capacitances 405 added to the vertical signal lines 132-1 to 132-4 are binned, and the potentials VSL1 to VSL4 of the vertical signal lines 132-1 to 132-4 are averaged. Then, the average value of the potentials VSL1 to VSL4 of the vertical signal lines 132-1 to 132-4 is input to each comparator 143. In addition, a ramp signal is supplied as a reference signal RAP to the activated comparator 143 (t26 to t27). Then, in the activated comparator 143, the average value of the potentials VSL1 to VSL4 of the vertical signal lines 132-1 to 132-4 corresponding to the signal level is compared with the reference signal RAP. Then, the timing when the level of the reference signal RAP matches the average value of the potentials VSL1 to VSL4 of the vertical signal lines 132-1 to 132-4 is output as the comparison result COP1. At this time, in the activated counter 146, a counting operation is performed until the level of the reference signal RAP matches the average value of the potentials VSL1 to VSL4 of the vertical signal lines 132-1 to 132-4. Then, based on the counting operation of the activated counter 146, the average value of the signal levels read out from each pixel 120 connected to the vertical signal lines 132-1 to 132-4 is AD-converted. After that, the sample-and-hold signal ΦS and the opening/closing signal ΦCn fall, and the selection signal ΦSEL of each pixel 120 falls.

In this way, in the eighth embodiment described above, binning is performed based on constant current readout. This allows the time required for settling to be reduced compared to capacitive load readout.

### 9. Ninth Embodiment

In the second embodiment described above, binning is performed based on capacitive load readout. In the ninth embodiment, a constant current transistor is connected in parallel to a series circuit of a signal line reset transistor 141 and a diode-connected transistor 142, making it possible to switch between constant current readout and capacitive load readout.

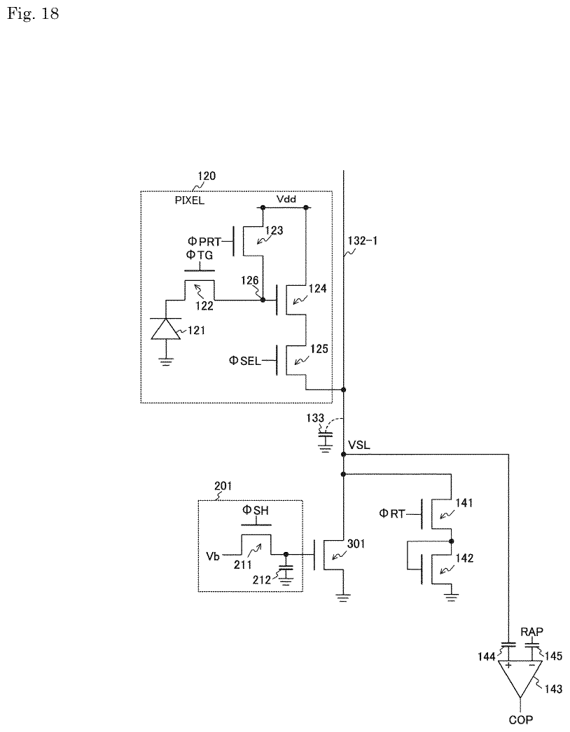

FIG. 18 is a block diagram showing an example of the configuration of a signal readout circuit for one column according to the ninth embodiment. Note that, although the FIGURE shows a signal readout circuit for one column, the other columns can be configured in the same way.

In the FIGURE, this signal readout circuit is obtained by adding a sample-and-hold circuit 201 and a constant current transistor 301 to the signal readout circuit of the second embodiment described above. The other configurations of the signal readout circuit of the ninth embodiment are similar to those of the signal readout circuit of the second embodiment described above.

The sample-and-hold circuit 201 samples and holds the bias voltage Vb, and applies it to the gate of the constant current transistor 301. The sample-and-hold circuit 201 includes a transistor 211 and a capacitor 212. The transistor 211 may be a MOS transistor. A sample-and-hold signal ΦSH is applied to the gate of the transistor 211. The capacitor 212 is connected between the source of the transistor 211 and the ground potential.

The constant current transistor 301 is electrically connected to the vertical signal line 132-1. The constant current transistor 301 may be a MOS transistor. The gate of the constant current transistor 301 is connected to the output of the sample-and-hold circuit 201.

Here, in the capacitive load readout, the bias voltage Vb is set to 0 V, and the sample-and-hold signal ΦSH is set to a high level. In this case, the constant current transistor 301 is turned off, and no current flows through the constant current transistor 301. The operation of the signal readout circuit at this time is similar to that of the signal readout circuit of the first embodiment described above.

In the constant current readout, in order to prevent cross-draw noise during AD conversion, the transistor 211 is turned on and the bias voltage Vb is sampled and held. Then, the transistor 211 is turned off and the bias voltage Vb sampled and held by the sample-and-hold circuit 201 is applied to the gate of the constant current transistor 301. In this case, the constant current transistor 301 is turned on and a constant current flows through the constant current transistor 301. The operation of the signal readout circuit at this time is similar to that of the signal readout circuit of the eighth embodiment described above.

As described above, in the ninth embodiment described above, the constant current transistor 301 is connected in parallel to the series circuit of the signal line reset transistor 141 and the diode-connected transistor 142. As a result, it is possible to perform binning in the column direction while suppressing an increase in the area of the signal readout circuit, and to switch between constant current readout and capacitive load readout.

### 10. Tenth Embodiment

In the first embodiment described above, the signal line reset transistor 141 performs binning based on the signal sampled and held for each column connected to the vertical signal lines 132-1 to 132-4. In this tenth embodiment, substrates on which a solid-state imaging device is formed, the solid-state imaging device having a pixel array unit in which pixels 120 are arranged in a matrix, are stacked.

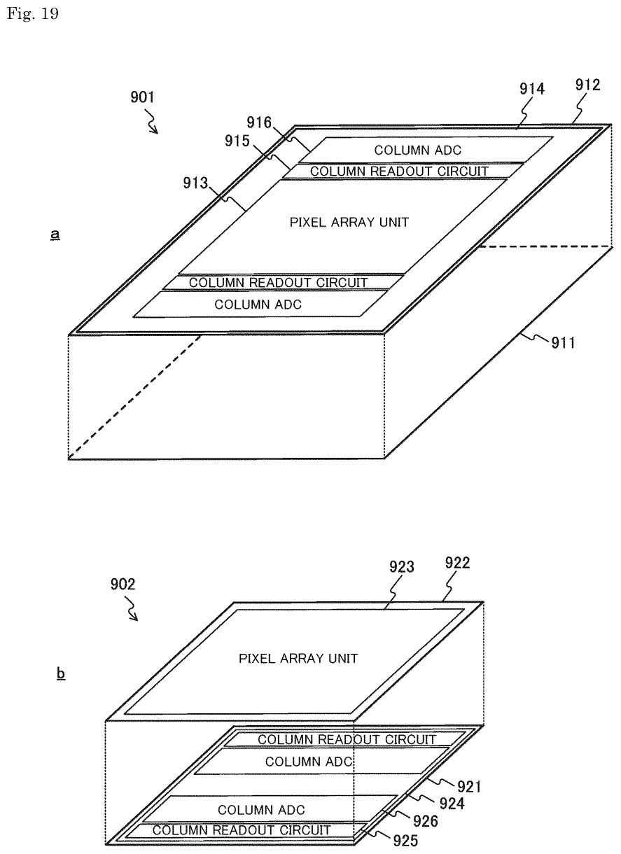

FIG. 19 is a perspective view showing an example of the configuration of an imaging device according to the tenth embodiment.

In FIG. 19, a solid-state imaging device 901 includes a support substrate 911 and a semiconductor substrate 912. The semiconductor substrate 912 is stacked on the support substrate 911. A pixel array unit 913 and a peripheral circuit 914 are formed on the semiconductor substrate 912. A column readout circuit 915 and a column ADC 916 are formed on the peripheral circuit 914. The column readout circuit 915 and the column ADC 916 may be formed on both sides of the pixel array unit 913 in the column direction.

The pixels 120 are arranged in a matrix in the row and column directions in the pixel array unit 913. The column readout circuit 915 can read out signals from each pixel 120 individually based on capacitive load readout, or can read out signals by binning. In the column readout circuit 915, for example, the signal line reset transistor 141 and the connection switch 151 in FIG. 6 may be formed. The column ADC 916 can perform AD conversion for each column of the signal read out via the column readout circuit 915. In this case, the solid-state imaging device 901 can constitute a back-illuminated image sensor.

In b of the FIGURE, the solid-state imaging device 902 includes semiconductor substrates 921 and 922. The semiconductor substrate 922 is stacked on the semiconductor substrate 921. A pixel array unit 923 is formed in the semiconductor substrate 922. A peripheral circuit 924 is formed in the semiconductor substrate 922. A column readout circuit 925 and a column ADC 926 are formed in the peripheral circuit 924. The column readout circuit 925 and the column ADC 926 may be formed so as to correspond to positions on both sides of the pixel array unit 923 in the column direction. In this case, the solid-state imaging device 902 can constitute a back-illuminated image sensor.

In this way, in the above-mentioned twelfth embodiment, the substrates on which the solid-state imaging devices 901 and 902 are formed are stacked. This allows the semiconductor substrates 912 and 922 on which the pixel array units 913 and 923 are formed to be thinned while supporting the pixel array units 913 and 923, respectively, and allows a back-illuminated image sensor to be formed.

### 11. Example of Application to Mobile Object

The technology according to the present disclosure (the present technology) can be applied to various products. For example, the technology according to the present disclosure may be realized as a device equipped in any type of mobile object such as an automobile, an electric vehicle, a hybrid electric vehicle, a motorcycle, a bicycle, a personal mobility device, an airplane, a drone, a ship, and a robot.

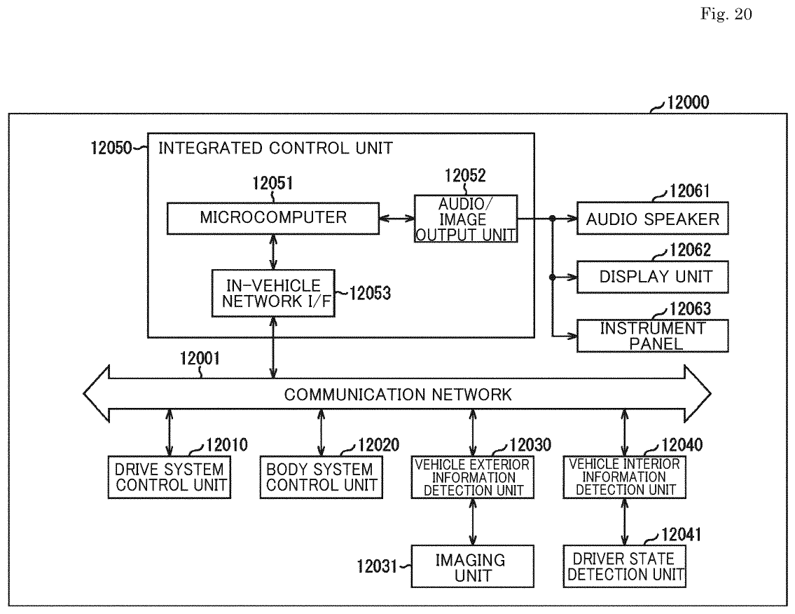

FIG. 20 is a block diagram illustrating a schematic configuration example of a vehicle control system which is an example of a mobile object control system to which the technology according to the present disclosure can be applied.

The vehicle control system 12000 includes a plurality of electronic control units connected thereto via a communication network 12001. In the example shown in FIG. 20, the vehicle control system 12000 includes a drive system control unit 12010, a body system control unit 12020, a vehicle exterior information detection unit 12030, a vehicle interior information detection unit 12040, and an integrated control unit 12050. In addition, as a functional configuration of the integrated control unit 12050, a microcomputer 12051, an audio/image output unit 12052, and an in-vehicle network interface (I/F) 12053 are shown.

The drive system control unit 12010 controls an operation of a device related to a drive system of a vehicle according to various programs. For example, the drive system control unit 12010 functions as a driving force generator for generating a driving force of a vehicle such as an internal combustion engine or a driving motor, a driving force transmission mechanism for transmitting a driving force to wheels, a steering mechanism for adjusting a turning angle of a vehicle, and a control device such as a braking device that generates a braking force of a vehicle.

The body system control unit 12020 controls the operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle.

The vehicle exterior information detection unit 12030 detects information on the outside of the vehicle having the vehicle control system 12000 mounted thereon. For example, an imaging unit 12031 is connected to the vehicle exterior information detection unit 12030. The vehicle exterior information detection unit 12030 causes the imaging unit 12031 to capture an image of the outside of the vehicle and receives the captured image. The vehicle exterior information detection unit 12030 may perform object detection processing or distance detection processing for people, cars, obstacles, signs, and letters on the road based on the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or non-visible light such as infrared light.

The vehicle interior information detection unit 12040 detects information on the inside of the vehicle. For example, a driver state detection unit 12041 that detects a driver's state is connected to the vehicle interior information detection unit 12040. The driver state detection unit 12041 includes, for example, a camera that captures an image of a driver, and the vehicle interior information detection unit 12040 may calculate the degree of fatigue or concentration of the driver or may determine whether or not the driver is dozing based on detection information input from the driver state detection unit 12041.

The microcomputer 12051 can calculate a control target value for the driving force generation device, the steering mechanism, or the braking device based on the information regarding the inside and outside of the vehicle which is acquired by the vehicle exterior information detection unit 12030 or the vehicle interior information detection unit 12040, and can output a control command to the drive system control unit 12010. For example, the microcomputer 12051 can perform cooperative control for the purpose of realizing the functions of an ADAS (advanced driver assistance system) including vehicle collision avoidance or impact mitigation, following traveling based on a following distance, vehicle speed maintenance travelling, a vehicle collision warning, a vehicle lane departure warning, and the like.

Further, the microcomputer 12051 can perform cooperative control for the purpose of automated driving or the like in which autonomous travel is performed without depending on operations of the driver, by controlling the driving force generator, the steering mechanism, or the braking device and the like based on information about the surroundings of the vehicle, the information being acquired by the vehicle exterior information detection unit 12030 or the vehicle interior information detection unit 12040.

In addition, the microcomputer 12051 can output a control command to the body system control unit 12020 based on the information acquired by the vehicle exterior information detection unit 12030 outside the vehicle. For example, the microcomputer 12051 can perform cooperative control for the purpose of preventing glare, such as switching from a high beam to a low beam, by controlling the headlamp according to the position of a preceding vehicle or an oncoming vehicle detected by the vehicle exterior information detection unit 12030.

The audio/image output unit 12052 transmits an output signal of at least one of sound and an image to an output device capable of visually or audibly notifying a passenger or the outside of the vehicle of information. In the example of FIG. 20, an audio speaker 12061, a display unit 12062, and an instrument panel 12063 are illustrated as examples of the output device. The display unit 12062 may include at least one of an on-board display and a head-up display, for example.

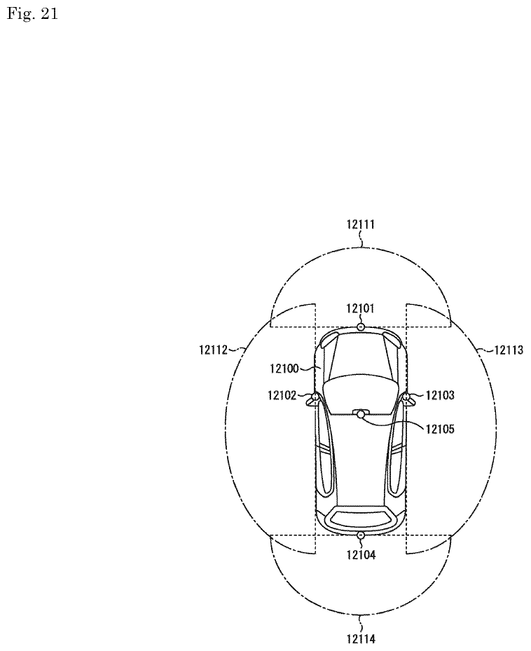

FIG. 21 is a diagram showing an example of an installation position of the imaging unit 12031.

In FIG. 21, imaging units 12101, 12102, 12103, 12104, and 12105 are provided as the imaging units 12031.

The imaging units 12101, 12102, 12103, 12104, and 12105 are provided at positions such as a front nose, side-view mirrors, a rear bumper, a back door, and an upper portion of a windshield in a vehicle interior of the vehicle 12100, for example. The imaging unit 12101 provided on the front nose and the imaging unit 12105 provided in the upper portion of the windshield in the vehicle interior mainly acquire images of the front of the vehicle 12100. The imaging units 12102 and 12103 provided on the side-view mirrors mainly acquire images of a lateral side of the vehicle 12100. The imaging unit 12104 provided on the rear bumper or the back door mainly acquires images of the rear of the vehicle 12100. The imaging unit 12105 provided in the upper portion of the windshield in the vehicle interior is mainly used for detection of preceding vehicles, pedestrians, obstacles, traffic signals, traffic signs, lanes, and the like.

FIG. 21 illustrates an example of the imaging ranges of the imaging units 12101 to 12104. An imaging range 12111 indicates an imaging range of the imaging unit 12101 provided at the front nose, imaging ranges 12112 and 12113 respectively indicate the imaging ranges of the imaging units 12102 and 12103 provided at the side-view mirrors, and an imaging range 12114 indicates the imaging range of the imaging unit 12104 provided at the rear bumper or the back door. For example, by superimposing image data captured by the imaging units 12101 to 12104, it is possible to obtain a bird's-eye view image viewed from the upper side of the vehicle 12100.

At least one of the imaging units 12101 to 12104 may have a function for obtaining distance information. For example, at least one of the imaging units 12101 to 12104 may be a stereo camera constituted by a plurality of imaging elements or may be an imaging element that has pixels for phase difference detection.

For example, the microcomputer 12051 can extract, particularly, the closest three-dimensional object on a path along which the vehicle 12100 is traveling, which is a three-dimensional object traveling at a predetermined speed (for example, 0 km/h or higher) in the substantially same direction as the vehicle 12100, as a vehicle ahead by acquiring a distance to each three-dimensional object in the imaging ranges 12111 to 12114 and a temporal change of this distance (a relative speed with respect to the vehicle 12100) based on the distance information obtained from the imaging units 12101 to 12104. Furthermore, the microcomputer 12051 can set an inter-vehicle distance to be secured from a vehicle ahead in advance with respect to the vehicle ahead and can perform automated brake control (also including following stop control) or automated acceleration control (also including following start control). In this way, cooperative control can be performed for the purpose of automated traveling or the like in which a vehicle automatedly travels without the operations of the driver.

For example, the microcomputer 12051 can classify and extract three-dimensional data regarding three-dimensional objects into two-wheeled vehicles, normal vehicles, large vehicles, pedestrians, and other three-dimensional objects such as electric poles based on distance information obtained from the imaging units 12101 to 12104 and can use the three-dimensional data to perform automated avoidance of obstacles. For example, the microcomputer 12051 differentiates surrounding obstacles of the vehicle 12100 into obstacles which can be viewed by the driver of the vehicle 12100 and obstacles which are difficult to view. Then, the microcomputer 12051 determines a collision risk indicating the degree of risk of collision with each obstacle, and when the collision risk is equal to or higher than a set value and there is a possibility of collision, an alarm is output to the driver through the audio speaker 12061 or the display unit 12062, forced deceleration or avoidance steering is performed through the drive system control unit 12010, and thus it is possible to perform driving support for collision avoidance.

At least one of the imaging units 12101 to 12104 may be an infrared camera that detects infrared rays. For example, the microcomputer 12051 can recognize a pedestrian by determining whether there is a pedestrian in the captured image of the imaging units 12101 to 12104. Such pedestrian recognition is performed by, for example, a procedure in which feature points in the captured images of the imaging units 12101 to 12104 as infrared cameras are extracted and a procedure in which pattern matching processing is performed on a series of feature points indicating an outline of an object to determine whether or not the object is a pedestrian. When the microcomputer 12051 determines that there is a pedestrian in the captured images of the imaging units 12101 to 12104 and the pedestrian is recognized, the audio/image output unit 12052 controls the display unit 12062 so that a square contour line for emphasis is superimposed and displayed with the recognized pedestrian. In addition, the audio/image output unit 12052 may control the display unit 12062 so that an icon indicating a pedestrian or the like is displayed at a desired position.

An example of the vehicle control system to which the technology according to the present disclosure can be applied has been described above. The technology according to the present disclosure can be applied to the imaging unit 12031 within the configuration described above. Specifically, for example, the above-mentioned camera 100 can be applied to the imaging unit 12031. By applying the technology according to the present disclosure to the vehicle control system 12000, it is possible to obtain a captured image while suppressing an increase in power consumption.

It should be noted that the above-described embodiments show examples of embodying the present technology, and matters in the embodiments and matters specifying the invention in the claims have a corresponding relationship with each other. Likewise, the items specifying the invention set forth in the scope of patent claims correspond to the items in the embodiments of the present technology which have the same names. However, the present technology is not limited to the embodiments and can be embodied by applying various modifications to the embodiments without departing from the gist thereof. Furthermore, the effects described in the present specification are merely exemplary and not intended to be limited, and other effects may be provided as well.

The present technology can also have the following configurations.
(1) An imaging device including:
a pixel array unit in which pixels are arranged in a matrix in a row direction and a column direction;
a signal line that transmits signals read out from the pixels in the column direction;
a sample-and-hold switch that samples and holds the signals, which are transmitted via the signal line, for each column; and
a connection switch that connects signal lines of different columns in which the signals are sampled and held.
(2) The imaging device according to (1), further including:
an AD conversion unit that performs AD conversion for each of the columns of the signals transmitted via the signal line; and
an active control unit that activates one AD conversion unit out of the AD conversion units of each column connected via the connection switch.
(3) The imaging device according to (2), wherein the AD conversion unit comprises:
a comparator that compares a potential of the signal line with a ramp signal; and
a counter that performs a counting operation, based on a comparison result from the comparator.
(4) The imaging device according to (3), wherein
the active control unit controls the AD conversion units, separately, for columns to be activated and columns to be deactivated.
(5) The imaging device according to (3) or (4), further including:
a first DC-cut capacitor connected to a first input terminal of the comparator; and
a second DC-cut capacitor connected to a second input terminal of the comparator.
(6) The imaging device according to (5), further including:
a changeover switch that switches between the first input terminal of the comparator and a ground a connection destination of a second capacitance electrode of the first DC-cut capacitor having a first capacitance electrode being connected to the signal line.
(7) The imaging device according to (6), wherein
the active control unit controls the changeover switch, separately, for columns to be activated and columns to be deactivated.
(8) The imaging device according to any one of (2) to (7), further including:
an amplifier that amplifies, for each column, signals transmitted via the signal line and inputs the amplified signals to the AD conversion unit.
(9) The imaging device according to (8), wherein
the active control unit controls the amplifier, separately, for columns to be activated and columns to be deactivated.
(10) The imaging device according to any one of (1) to (9), wherein the sample-and-hold switch is a transistor provided for each signal line.
(11) The imaging device according to (10), further including:
a driver that drives the transistor from both sides in the row direction.
(12) The imaging device according to any one of (1) to (11), further including:
a signal line reset transistor that resets the potential of the signal line; and
a signal line reset level generating unit that generates a reset level of the potential of the signal line.
(13) The imaging device according to (12), wherein
the signal line reset level generating unit comprises a diode-connected transistor.
(14) The imaging device according to any one of (1) to (13), wherein a capacitance used for sampling and holding the signal is a parasitic capacitance of the signal line.
(15) The imaging device according to any one of (1) to (14), wherein the connection switch is connected, in series, to a capacitance for each column used for sampling and holding the signal.
(16) The imaging device according to any one of (1) to (14), wherein the connection switch is connected, in parallel, to a capacitance for each column used for sampling and holding the signal.
(17) The imaging device according to any one of (1) to (16), further including:
a constant current transistor electrically connectable to the signal line and passing a constant current, based on a source follower formed between the signal line and the pixel, wherein
the constant current transistor is turned on during constant current readout, and
the constant current transistor is turned off during capacitive load readout.
(18) The imaging device according to any one of (1) to (17), wherein the pixel includes:
a photodiode;
a transfer transistor that transfers charges stored in the photodiode to a floating diffusion;
a reset transistor that resets the floating diffusion;
an amplification transistor that outputs a signal corresponding to a potential of the floating diffusion; and
a selection transistor connected between the amplification transistor and the signal line.
(19) The imaging device according to (19), wherein the sample-and-hold switch is the selection transistor.
(20) The imaging device according to (18) or (19), further including:
a binning transistor that connects floating diffusions of different rows.

[Reference Signs List]

| | |
|---|---|
| 100 | Camera |
| 101 | Optical system |
| 102 | Solid-state imaging device |
| 103 | Imaging control unit |
| 104 | Image processing unit |
| 105 | Storage unit |
| 106 | Display unit |
| 107 | Operation unit |
| 108 | Bus |
| 111 | Pixel array unit |
| 112 | Vertical scanning circuit |
| 113 | Column readout circuit |
| 114 | Column signal processing unit |
| 115 | Horizontal scanning circuit |
| 116 | Control circuit |
| 117, 118 | Driver |
| 119 | Active control unit |
| 121 | Photodiode |
| 122 | Transfer transistor |
| 123 | Reset transistor |
| 124 | Amplification transistor |
| 125 | Selection transistor |
| 126 | Floating diffusion |
| 131 | Horizontal drive line |
| 132 | Vertical signal line |
| 133 | Capacitance |
| 141 | Signal line reset transistor |
| 142 | Diode-connected transistor |
| 143 | Comparator |
| 144, 145 | DC-cut capacitor |
| 146 | Counter |
| 151 | Connection switch |

1. An imaging device comprising:
a pixel array unit in which pixels are arranged in a matrix in a row direction and a column direction;
a signal line that transmits signals read out from the pixels in the column direction;
a sample-and-hold switch that samples and holds the signals, which are transmitted via the signal line, for each column; and
a connection switch that connects signal lines of different columns in which the signals are sampled and held.

2. The imaging device according to claim 1, further comprising:
an AD conversion unit that performs AD conversion for each of the columns of the signals transmitted via the signal line; and
an active control unit that activates one AD conversion unit out of the AD conversion units of each column connected via the connection switch.

3. The imaging device according to claim 2, wherein the AD conversion unit comprises:
a comparator that compares a potential of the signal line with a ramp signal; and
a counter that performs a counting operation, based on a comparison result from the comparator.

4. The imaging device according to claim 2, wherein
the active control unit controls the AD conversion units, separately, for columns to be activated and columns to be deactivated.

5. The imaging device according to claim 3, further comprising:
a first DC-cut capacitor connected to a first input terminal of the comparator; and
a second DC-cut capacitor connected to a second input terminal of the comparator.

6. The imaging device according to claim 5, further comprising:
a changeover switch that switches between the first input terminal of the comparator and a ground a connection destination of a second capacitance electrode of the first DC-cut capacitor having a first capacitance electrode being connected to the signal line.

7. The imaging device according to claim 6, wherein
the active control unit controls the changeover switch, separately, for columns to be activated and columns to be deactivated.

8. The imaging device according to claim 2, further comprising:
an amplifier that amplifies, for each column, signals transmitted via the signal line and inputs the amplified signals to the AD conversion unit.

9. The imaging device according to claim 8, wherein
the active control unit controls the amplifier, separately, for columns to be activated and columns to be deactivated.

10. The imaging device according to claim 1, wherein
the sample-and-hold switch is a transistor provided for each signal line.

11. The imaging device according to claim 10, further comprising:
a driver that drives the transistor from both sides in the row direction.

12. The imaging device according to claim 1, further comprising:
a signal line reset transistor that resets the potential of the signal line; and
a signal line reset level generating unit that generates a reset level of the potential of the signal line.

13. The imaging device according to claim 4, wherein
the signal line reset level generating unit comprises a diode-connected transistor.

14. The imaging device according to claim 1, wherein
a capacitance used for sampling and holding the signal is a parasitic capacitance of the signal line.

15. The imaging device according to claim 1, wherein
the connection switch is connected, in series, to a capacitance for each column used for sampling and holding the signal.

16. The imaging device according to claim 1, wherein
the connection switch is connected, in parallel, to a capacitance for each column used for sampling and holding the signal.

17. The imaging device according to claim 1, further comprising:
a constant current transistor electrically connectable to the signal line and passing a constant current, based on a source follower formed between the signal line and the pixel, wherein
the constant current transistor is turned on during constant current readout, and
the constant current transistor is turned off during capacitive load readout.

18. The imaging device according to claim 1, wherein the pixel comprises:
a photodiode;
a transfer transistor that transfers charges stored in the photodiode to a floating diffusion;
a reset transistor that resets the floating diffusion;
an amplification transistor that outputs a signal corresponding to a potential of the floating diffusion; and
a selection transistor connected between the amplification transistor and the signal line.

19. The imaging device according to claim 18, wherein
the sample-and-hold switch is the selection transistor.

20. The imaging device according to claim 18, further comprising:
a binning transistor that connects floating diffusions of different rows.
